(19) United States
(12) Patent Application Publication
(10) Pub. No.: US 2018/0200575 A1
(43) Pub. Date: Jul. 19, 2018

(54) MOTION ANALYZING APPARATUS, MOTION ANALYZING SYSTEM, AND MOTION ANALYZING METHOD

(71) Applicant: SEIKO EPSON CORPORATION, Tokyo (JP)

(72) Inventors: Michihiro NAGAISHI, Suwa-shi (JP); Takuya SUGIMOTO, Shiojiri-shi (JP)

(73) Assignee: SEIKO EPSON CORPORATION, Tokyo (JP)

(21) Appl. No.: 15/865,747

(22) Filed: Jan. 9, 2018

(30) Foreign Application Priority Data
Jan. 16, 2017 (JP) 2017-004881
Jan. 16, 2017 (JP) 2017-004883
Jan. 16, 2017 (JP) 2017-004884

(51) Int. Cl. A63B 24/00; A63B 69/36; A63B 69/38; G06K 9/00; G09B 19/00; A63F 13/211; G06T 11/20

(52) U.S. Cl. CPC A63B 24/0006; A63B 69/3632; A63B 69/38; G06K 9/00342; A63B 2220/803; A63F 13/211; G06T 11/206; A63B 2220/24; A63B 2220/833; G09B 19/0038

(57) ABSTRACT

A swing analyzing apparatus as a motion analyzing apparatus includes a computation unit (a swing diagnostic device) that quantifies a swing of a golf based on an output of an inertial sensor (an acceleration sensor and an angular velocity sensor), a storage unit that stores a numerical value which is obtained by quantifying a plurality of the swings, and an output unit (a processing unit) that detects the numerical value deviating from a predetermined range among a plurality of the numerical values and outputs a play state.

### CROSS-REFERENCE TO RELATED APPLICATION

This application claims priority of Japanese Patent Application No. 2017-004881, filed Jan. 16, 2017, No. 2017-004883, filed Jan. 16, 2017 and No. 2017-004884, filed Jan. 16, 2017, which are expressly incorporated herein by reference thereto in its entirety.

### BACKGROUND

### 1. Technical Field

The present invention relates to a motion analyzing apparatus, a motion analyzing system, and a motion analyzing method.

### 2. Related Art

In recent years, an apparatus (a motion analyzing apparatus) for analyzing a motion of a subject (human) in various fields is required. For example, by analyzing a motion form of a subject (athlete) such as a swing trajectory of exercise equipment such as a golf club, a tennis racket, or a baseball bat and selecting the exercise equipment suitable for the subject from the analysis result, and improving the exercise form, an athletic performance can be improved.

With such a motion analyzing apparatus, a method in which play data of a golf player is recorded as a profile of the player, the data is compared with an average player profile average, and training such as filling up the difference is advised by display, for example, is described (For example, see JP-T-2003-506168).

In sports, not limited to golf, it is known that based on the mistake when playing the sports, exercise after knowing of a weak point of a play is good. However, since in the well-known method according to the motion analyzing apparatus of JP-T-2003-506168, only the difference in a general average level can be known, the weak point of the play cannot be known. Accordingly, it cannot reach a state where the player can exercise after knowing the weak point of the play.

### SUMMARY

An advantage of some aspects of the invention is to solve at least a part of the problems described above, and the invention can be implemented as the following forms or application examples.

### Application Example 1

A motion analyzing apparatus according to this application example includes a computation unit that quantifies a swing of a golf based on an output of an inertial sensor, a storage unit that stores a numerical value which is obtained by quantifying a plurality of the swings, and an output unit that detects the numerical value deviating from a predetermined range among a plurality of the numerical values and outputs a play state.

According to the motion analyzing apparatus of this application example, since it is detected whether the numerical value which is obtained by quantifying a plurality of the golf swings based on the output of the inertial sensor deviates from the predetermined range, and the play state is output by the output unit based on the detection result, the weak point in a user's swing of a golf can be known. As a result, the user can exercise the play after knowing the weak point of the play and can perform efficient exercise corresponding to the weak point.

The play state indicates an actual state of an operation including the user's golf swing, movement and the like, a strong point, and a weak point.

### Application Example 2

In the motion analyzing apparatus according to the application example, it is preferable that a motion state in the golf swing is quantified, and the motion state includes a plurality of quantifiable indices.

According to this application example, the motion state in the golf swing is quantified by the plurality of quantifiable indices and it is possible to detect that the numerical value deviates from the predetermined range of the plurality of indices. Accordingly, it is possible to more precisely perform the output in the play state.

### Application Example 3

In the motion analyzing apparatus according to the application example, it is preferable that the output unit outputs the play state from an input result of a golf score and a plurality of detection results.

According to this application example, since the play state is output with a combination of the detection result of the motion state, which is quantified based on the output from the inertial sensor, in the plurality of swings of golf and the input result in the golf score, it is possible to more precisely perform the output in the play state.

### Application Example 4

In the motion analyzing apparatus according to the application example, it is preferable that the output unit outputs the play state from golf equipment information and the detection result.

According to this application example, since the play state is output with a combination of the detection result of the motion state in the golf swing, which is quantified based on the output from the inertial sensor, and the golf equipment information, it is possible to more precisely perform the output in the play state.

### Application Example 5

In the motion analyzing apparatus according to the application example, it is preferable that the motion analyzing apparatus further includes a position information acquisition unit, in which the output unit outputs the play state from an acquisition result of position information from the position information acquisition unit and the detection result.

According to this application example, since the play state is output with a combination of the detection result of the motion state, which is quantified based on the output from the inertial sensor, and the acquisition result of the position information from the position information acquisition unit, it is possible to more precisely perform the output in the play state including the motion state in the golf swing of the user or the like.

### Application Example 6

In the motion analyzing apparatus according to the application example, it is preferable that the play state is a number of a good or weak hole or club.

According to this application example, since the number of the good or weak hole or club can be easily confirmed, the user can easily overlook one play in a golf round or the like.

### Application Example 7

A motion analyzing system according to this application example includes an inertial sensor, an computation unit that quantifies a swing of a golf based on an output of the inertial sensor, a storage unit that stores a numerical value which is obtained by quantifying a plurality of the swings, and an output unit that detects the numerical value, which is quantified by the computation unit, deviating from a predetermined range among a plurality of the numerical values and outputs a play state from the detection result in the plurality of swings.

According to the motion analyzing system of this application example, the computation unit detects whether the numerical value which is obtained by quantifying the golf swing based on the output of the inertial sensor deviates from the predetermined range, and the output unit outputs the play state from the detection result, the user can know the weak point in his or her own golf swing. As a result, the user can exercise the play after knowing the weak point of the play, and can perform efficient exercise corresponding to the weak point.

### Application Example 8

In the motion analyzing system according to the application example, it is preferable that the motion analyzing system further includes a position information acquisition unit, in which the output unit outputs the play state from an acquisition result of position information from the position information acquisition unit and the detection result.

According to this application example, since the play state is output with a combination of the detection result of the motion state in the golf swing, which is quantified based on the output from the inertial sensor, and the acquisition result of the position information from the position information acquisition unit, it is possible to more precisely perform the output in the play state including the motion state in the golf swing of the user or the like.

### Application Example 9

A motion analyzing method according to this application example includes quantifying a swing of a golf based on an output of an inertial sensor, storing a numerical value which is obtained by quantifying a plurality of the swings, and detecting the numerical value, which is quantified by the operation unit, deviating from a predetermined range among a plurality of the numerical values and outputting a play state from the detection result in the plurality of swings.

According to the motion analyzing method of this application example, since it is detected whether the numerical value which is obtained by quantifying a plurality of the golf swings based on the output of the inertial sensor deviates from the predetermined range, and the play state is output from the detection result. Accordingly, the user can know the weak point in his or her own golf swing, can exercise the play after knowing the weak point of the play, and can perform efficient exercise corresponding to the weak point.

### Application Example 10

In the motion analyzing method according to the application example, it is preferable that the motion state in the golf swing includes a plurality of quantifiable indices.

According to this application example, since the motion state in the golf swing is quantified by the plurality of quantifiable indices, it is possible to detect that the numerical value deviates from the predetermined range of the plurality of indices. Accordingly, it is possible to more precisely perform the output in the play state.

### BRIEF DESCRIPTION OF THE DRAWINGS

The invention will be described with reference to the accompanying drawings, wherein like numbers reference like elements.

FIG. 1 is a diagram illustrating a configuration example of a motion analyzing system according to the present embodiments.

FIG. 2 is a diagram illustrating a sensor unit and a swing analyzing apparatus.

FIG. 3 is a diagram illustrating an example of an apparatus position and a direction of the sensor unit.

FIG. 4 is a diagram illustrating a procedure of an operation performed before a user hits a ball.

FIG. 5 is an explanatory diagram of a swing operation.

FIG. 6 is a diagram illustrating a configuration example of the sensor unit and the swing analyzing apparatus.

FIG. 7 is a plan view of a golf club and a sensor unit viewed from a negative side of an X-axis when a user stands still.

FIG. 8 is a characteristic diagram illustrating an example of a temporal change in 3-axis angular velocity.

FIG. 9 is a characteristic diagram illustrating a temporal change in a composite value of the 3-axis angular velocity.

FIG. 10 is a characteristic diagram illustrating a temporal change in a differentiation of the composite value.

FIG. 11 is a diagram illustrating a shaft plane and Hogan's plane.

FIG. 12 is a diagram of the shaft plane cut along a YZ plane as viewed from the negative side of an X-axis.

FIG. 13 is a diagram of Hogan's plane cut along a YZ plane as viewed from the negative side of an X-axis.

FIG. 14 is a diagram for illustrating a face angle and a club path (an incident angle).

FIG. 15 is a diagram illustrating an example of a time variation of a shaft axis rotation angle from a swing start (a backswing start) to an impact.

FIG. 16 is a diagram illustrating an example of the time variation of the velocity of grip in the downswing.

FIG. 17 is a diagram for illustrating a definition of an attack angle (a first angle) of a striking portion in the impact.

FIG. 18 is a flowchart illustrating an example of a procedure of a swing analysis process (a swing analyzing method).

FIG. 19 is a diagram illustrating a configuration example of the swing diagnostic device.

FIG. 20A is a diagram illustrating an example of a relationship between the shaft plane and the Hogan's plane, and a plurality of regions.

FIG. 20B is a diagram showing an example of a schematic of the shaft plane and the Hogan's plane, and a posture of a user.

FIG. 21 is a flowchart illustrating an example of a procedure of a motion analyzing method according to the present embodiment.

FIG. 22 is a diagram illustrating an example of quantifying (scoring) the state of the swing.

FIG. 23 is a diagram illustrating an example of a method for specifying a weak hole.

FIG. 24 is a diagram illustrating an example of an analysis result of the swing relating to the weak hole.

FIG. 25 is a diagram illustrating a comparison of scores for hit balls (shots) of the weak hole.

FIG. 26 is a diagram illustrating a typical example of a change in acceleration from the start to the end of the shot.

FIG. 27 is a diagram illustrating an example of an elapsed time for hit balls (shots) relating to weak holes #1 and #5.

FIG. 28 is a time chart illustrating an example of a time procedure of recording of the motion analyzing method.

FIG. 29 is a diagram illustrating a display example 1 (entire) used for advice on user's weak point obtained from an analysis result.

FIG. 30 is a diagram illustrating a display example 2 (a weak hole) used for advice on the user's weak point obtained from the analysis result.

FIG. 31 is a diagram illustrating a display example 3 (a situation of each hole) used for advice on the user's weak point obtained from the analysis result.

FIG. 32 is a diagram illustrating a display example 4 (a score situation for hitting balls relating to the weak hole) used for advice on the user's weak point obtained from the analysis result.

FIG. 33 is a diagram illustrating a display example 5 (an analysis result of the swing) used for advice on the user's weak point obtained from the analysis result.

FIG. 34 is a diagram illustrating a display example 6 (an elapsed time of swing for hitting balls) used for advice on the user's weak point obtained from the analysis result.

### DESCRIPTION OF EXEMPLARY EMBODIMENTS

Embodiments of the invention will be described in detail below with reference to the drawings. Note that the following embodiments do not unduly limit the scope of the invention as described in the appended claims. In addition, all of the elements described in connection with the following embodiments should not necessarily be taken as essential elements of the invention.

### 1. Motion Analyzing System

### 1-1. Configuration of Motion Analyzing System

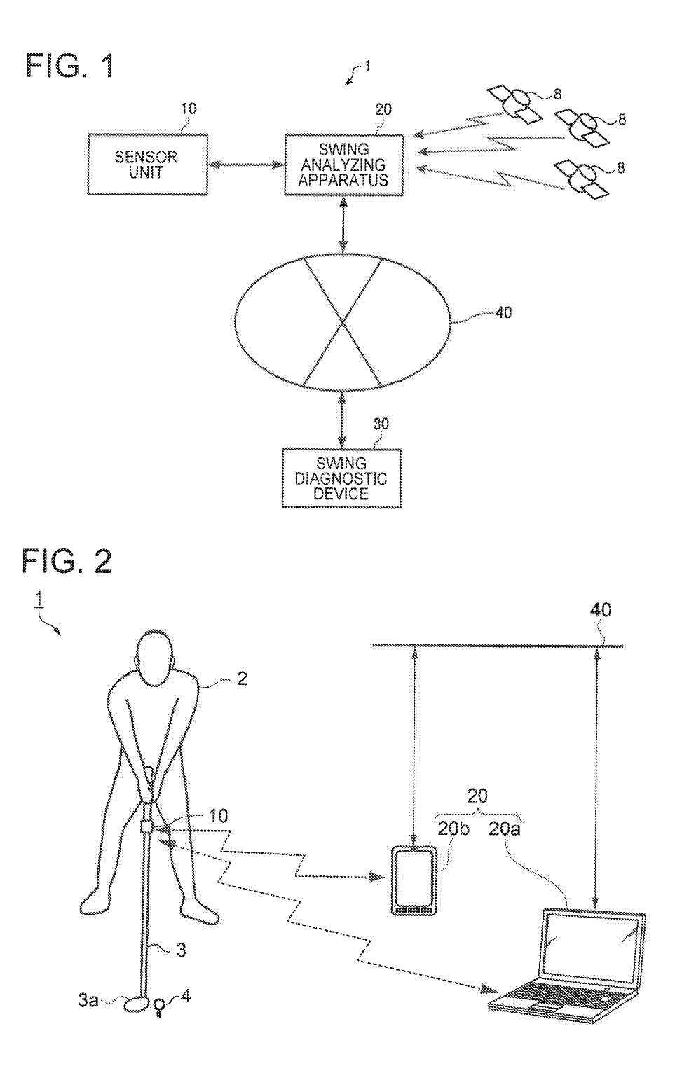

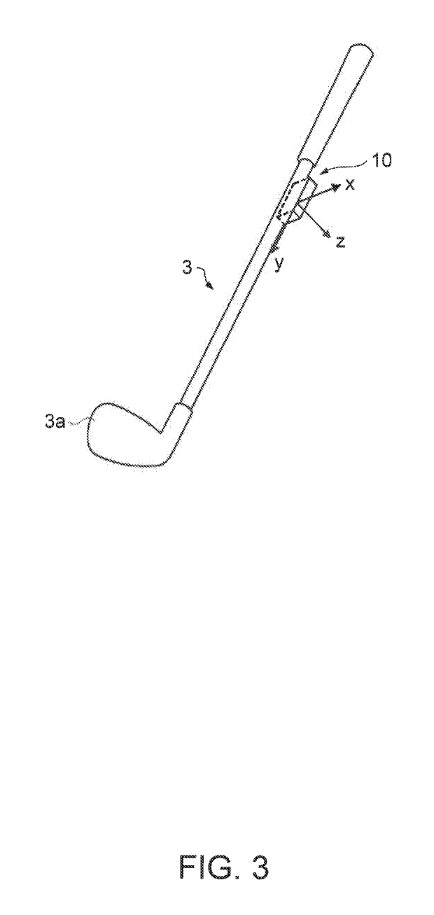

Hereinafter, as an example of motion analysis, a motion analyzing system will be described by exemplifying analysis of a swing of a golf (hereinafter, referred to as a golf swing) with reference to FIGS. 1, 2, and 3. FIG. 1 is a diagram illustrating a configuration example of a motion analyzing system according to the present embodiments. FIG. 2 is a diagram illustrating a sensor unit and a swing analyzing apparatus. FIG. 3 is a diagram illustrating an example of an apparatus position and a direction of the sensor unit.

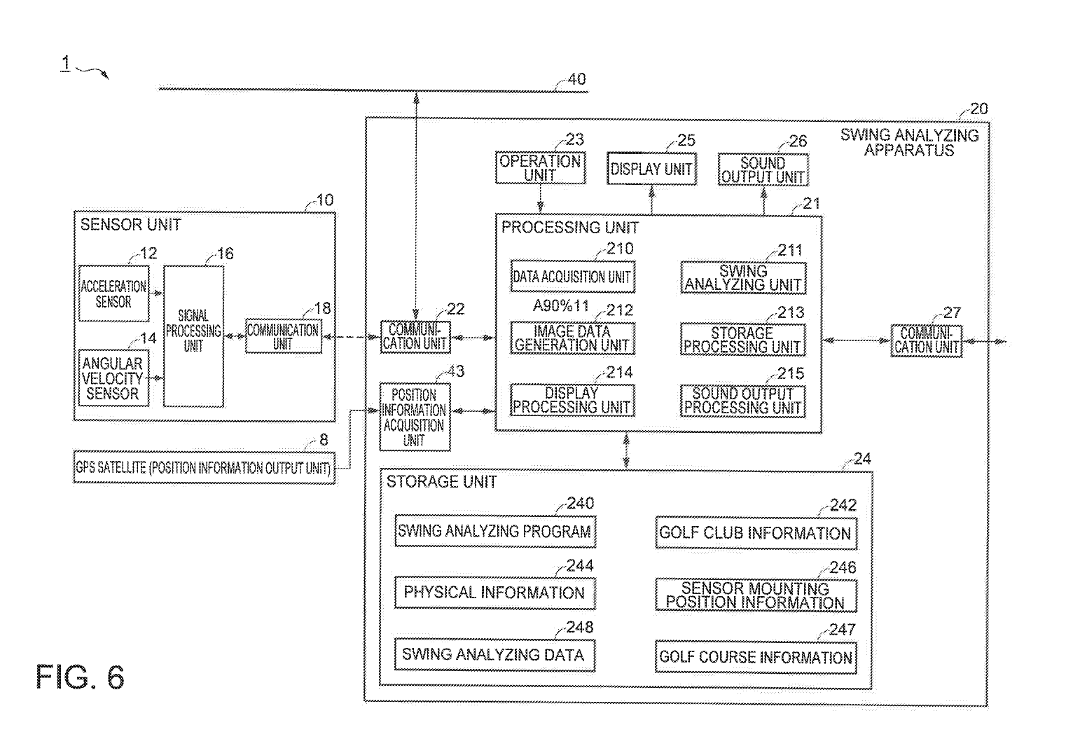

As illustrated in FIG. 1, a motion analyzing system 1 of the present embodiment includes a sensor unit (an example of an inertial sensor) 10 and a swing analyzing apparatus (an example of a motion analyzing apparatus) 20. As illustrated in FIG. 1, the motion analyzing system 1 includes a GPS satellite (a position information output unit) 8 and a position information acquisition unit 43 (see FIG. 6) included in the swing analyzing apparatus 20, and can include a function of receiving position information included in a radio wave (a satellite signal) from the GPS satellite 8 and performing a positioning calculation (acquisition of position information). The communication between the sensor unit 10 and the swing analyzing apparatus 20 may be wireless communication or wired communication. As illustrated in FIG. 2, in addition to a personal computer 20a, the swing analyzing apparatus 20 is realized by various information terminals (client terminals) such as mobile equipment 20b such as a smartphone or a tablet, or a wearable terminal such as a head mounted display (HMD) and wrist equipment in addition to a personal computer 20a.

The motion analyzing system 1 may include a swing diagnostic device 30 separately from the swing analyzing apparatus 20. However, the swing diagnostic device 30 may be included in the swing analyzing apparatus 20. The swing diagnostic device 30 may be realized by a server that processes a request from the swing analyzing apparatus 20. The swing analyzing apparatus 20 and the swing diagnostic device 30 are connected to each other via a network 40. The network 40 may be a wide area network (WAN) such as the Internet or a local area network (LAN). Alternatively, the swing analyzing apparatus 20 and the swing diagnostic device 30 may communicate via the network 40, for example, by near-field communication or wired communication.

The sensor unit 10 can measure acceleration in each axis direction of three axes orthogonally related to each other, for example, angular velocities around three axes orthogonal to each other, and as illustrated in FIG. 2, is mounted on a motion tool, for example, a golf club 3.

As illustrated in FIG. 3, for example, the sensor unit 10 is amount of the golf club 3 (an example of the motion tool) such that directions of three detection axes (an x-axis, a y-axis, and a z-axis) that intersect with each other (ideally orthogonal to each other) are aligned. In FIG. 3, for example, the y-axis is set in the longitudinal direction of the shaft of the golf club 3 (the longitudinal direction of the golf club 3), for example, the x-axis is aligned with a target direction of the hitting (hitting target direction). Preferably, the sensor unit 10 is attached at a position close to a grip, which is hard to transmit an impact at the time of hitting the ball and is difficult to be subjected to a centrifugal force at the time of swing. The shaft is a handle portion excluding a head (hitting portion) 3a of the golf club 3 and also includes a grip. However, the sensor unit 10 may be attached to a site (for example, a hand or a glove) of a user 2, or may be attached to an accessory such as a wristwatch.

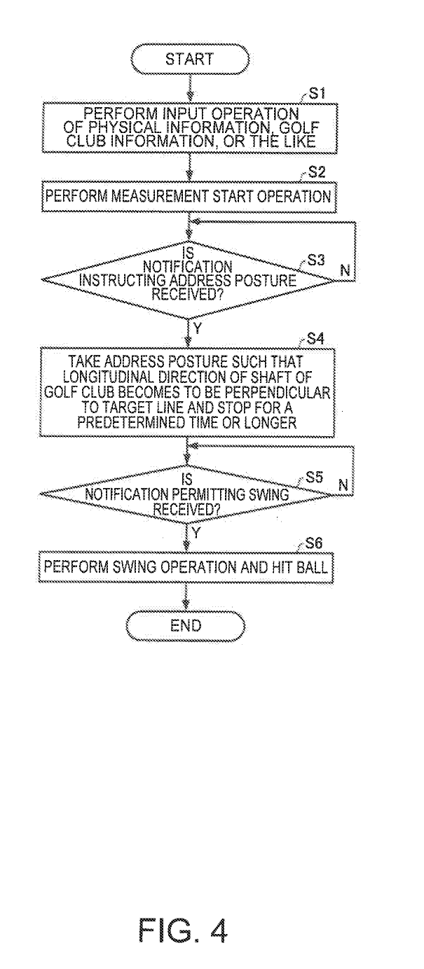

The user 2 performs a swing operation for hitting a golf ball 4 or a swing operation by practice swing based on a predetermined procedure. FIG. 4 is a diagram illustrating a procedure of an operation performed before the user 2 hits a ball. As illustrated in FIG. 4, first, the user 2 performs an input operation of physical information of the user 2 and information (golf club information) on the golf club 3 used by the user 2 via the swing analyzing apparatus 20 (S1).

In step S1 of FIG. 4, the user 2 inputs the physical information such as height, gender, age, country, and the like on an input screen (not illustrated) and inputs the golf club information such as a club length (a shaft length), a number, and the like. In addition, the information included in the physical information is not limited to this, and for example, the physical information may include information of at least one of an arm length and a leg length instead of the height or with the height. Similarly, the information included in the golf club information is not limited thereto. For example, the golf club information may not include any one of the club length and the number, or may include other information.

Next, the user 2 performs a measurement start operation (operation for causing the sensor unit 10 to start measurement) via the swing analyzing apparatus 20 (S2). The user 2 receives a notification (for example, voice notification) instructing the swing analyzing apparatus 20 to take an address posture (a basic posture before starting the swing) (S3 is Y), and then the user 2 takes the address posture such that the longitudinal direction of the shaft of the golf club 3 becomes to be perpendicular to a target line (the target direction of the hitting) and stops for a predetermined time or longer (S4). Next, the user 2 receives the notification (for example, the voice notification) permitting the swing from the swing analyzing apparatus 20 (S5 is Y), and then, performs the swing operation and hits the golf ball 4 (S6). The present embodiment is not necessarily limited to hit balls, but can also be applied to the practice swing, and may have a function of detecting the timing corresponding to the hitting balls.

When the user 2 performs the measurement start operation of step S2 in FIG. 4, the swing analyzing apparatus 20 transmits a measurement start command to the sensor unit 10, and the sensor unit 10 receives the measurement start command and starts measuring the three-axis acceleration and the three-axis angular velocity. The sensor unit 10 measures the three-axis acceleration and the three-axis angular velocity at a predetermined cycle (for example, 1 ms), and sequentially transmits the measured data to the swing analyzing apparatus 20.

The swing analyzing apparatus 20 notifies the user 2 of the permission to start the swing illustrated in step S5 of FIG. 4 and then analyzes the swing operation that the user 2 hits the ball using the golf club 3 based on the measurement data of the sensor unit 10 (step S6 in FIG. 4).

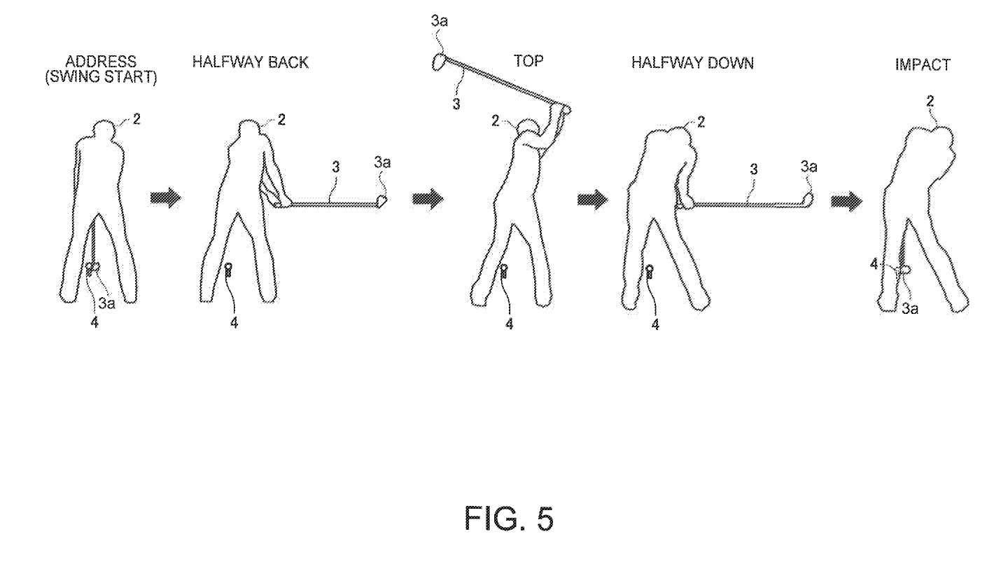

As illustrated in FIG. 5, the swing operation performed by the user 2 in step S6 of FIG. 4 includes an operation that leads to an impact (hitting ball) that the user hits the golf ball 4 via each state of a halfback where the shaft of the golf club 3 is leveled during backswing, a top where the posture is switched from the backswing to the downswing, and a halfway down where the shaft of the golf club 3 is leveled during downswing, after the user 2 starts swinging (backswing) from the address posture (a stationary state). Then, the swing analyzing apparatus 20 generates swing analysis data including information items of a time (day and time) at which the swing is performed, the identification information and gender of the user 2, the type of the golf club 3, and the analysis result of the swing operation, and transmits the swing analysis data to the network 40 (see FIG. 1) to the swing diagnostic device 30.

The swing diagnostic device 30 receives and stores the swing analysis data transmitted by the swing analyzing apparatus 20 via the network 40. Accordingly, every time when the user 2 performs the swing operation in accordance with the procedure of FIG. 4, the swing analysis data generated by the swing analyzing apparatus 20 is stored in the swing diagnostic device 30, and a swing analysis data list is constructed.

In the present embodiment, when the user 2 activates a swing diagnosis application via an operation unit 23 (see FIG. 6) of the swing analyzing apparatus 20, the swing analyzing apparatus 20 communicates with the swing diagnostic device 30, and a selection screen (not illustrated) of the swing analysis data is displayed on a display unit 25 (see FIG. 6) of the swing analyzing apparatus 20. In this selection screen, regarding each swing analysis data of user 2 included in the swing analysis data list stored in the swing diagnostic device 30, the time (day and time), the type of the golf club to be used, and a part of an index value as the analysis result of the swing are included.

In this selection screen, there is a check box corresponding to each swing analysis data. The user 2 checks any one of checkboxes through the operation of the swing analyzing apparatus 20. Accordingly, the swing analyzing apparatus 20 communicates with the swing diagnostic device 30, and on the display unit 25 of the swing analyzing apparatus 20, regarding the swing analysis data items corresponding to the checkboxes checked on the selection screen, for example, an input data editing screen (not illustrated) for swing diagnosis is displayed. In the input data editing screen, relating to the gender, the type of the golf club (whether the golf club is a driver or an iron), each index of the swing, the values obtained based on the selected swing analysis data are included as an initial value.

In the input data editing screen, the input data items of the gender, the type of the golf club, and each index value can be edited. The user 2 can edit the input data through the operation unit 23 (see FIG. 6) of the swing analyzing apparatus 20. In addition, the user 2 inputs a score of the golf for each hole, for example, as the input data from the input data editing screen. According to these, the swing analyzing apparatus 20 transmits the input data to the swing diagnostic device 30.

The swing diagnostic device 30 receives the input data (the input result) and calculates levels of a plurality of items using the input data. For example, regarding each of items “V zone”, “Rotation”, “Speed”, “Impact”, “Swing Pace”, and “Swing Efficiency”, the swing diagnostic device 30 may calculate each level on a scale of one to five, for example. The meaning and the calculation method of these five items will be described. In addition, the swing diagnostic device 30 may also calculate a total point of the swing from the each level of the five items. The swing diagnostic device 30 transmits the information of the level of the plurality of calculated items and the total point to the swing analyzing apparatus 20. For example, the “level” may be represented by scores such as “1, 2, 3, 4, 5” or, and may be represented by “A, B, C, . . . ”, or “◯, Δ, X, . . . ”.

The swing analyzing apparatus 20 receives the information of the level of the plurality of items and the total point, and displays the swing diagnosis screen on the display unit 25. From the swing diagnosis screen, the user 2 can grasp the level of the plurality of items and the total points as the diagnosis result for the input data of a left side. In particular, the user 2 can grasp the strong point and the weak point of his or her own swing from the swing diagnostic screen. In addition, the user 2 can also grasp, for example, to what extent the index to be improved to overcome the weak point. Hereinafter, an example of expressing “level” of the plurality of items by “scores” will be described.

In addition, the swing analyzing apparatus 20 detects the numerical value deviating from a predetermined range among the numerical values which is quantified with respect to the plurality of golf swings, and can display the numerical value on the display unit 25 by outputting the play state.

In addition, the swing analyzing apparatus 20 detects that the numerical value which is obtained by quantifying the motion state in the golf swing is deviated from the predetermined range, outputs the play state from the detection result in the plurality of swings, and can display the play state on the display unit 25. The play state in the present specification indicates an actual state of an operation including the golf swing, movement and the like of the user 2, a strong point, and a weak point. For example, by acquiring the plurality of detection results during a golf round, numbers of a good or weak hole or club which is one form of the play state can be output.

In addition, the above-described predetermined range can adopt any one of a value with the largest difference from the average value of the numerical values which are obtained by quantifying the motion state in the plurality of swings of the golf is the maximum value, a value which is obtained by adding a predetermined ratio to the average value to the average value of the numerical values, or a minimum value or a maximum value of the numerical value. If setting the predetermined range in such a manner, it is possible to easily detect the deviation of the numerical value which is obtained by quantifying the motion state in the golf swing.

In addition, it is preferable that the above-described numerical value includes a plurality of indices which can quantify the motion state in the golf swing. In this manner, the motion state in the golf swing is quantified by the plurality of quantifiable indices and it is possible to detect that the numerical value is deviated from the predetermined range of the plurality of indices. Accordingly, it is possible to more precisely perform the output in the play state.

### 1-2. Configurations of Sensor Unit and Swing Analyzing Apparatus

FIG. 6 is a diagram illustrating a configuration example of the sensor unit 10 and the swing analyzing apparatus 20. As illustrated in FIG. 6, the sensor unit 10 may be configured by including an acceleration sensor 12, an angular velocity sensor 14, a signal processing unit 16, and a communication unit 18. However, the sensor unit 10 may have a configuration in which some of these constituent elements are deleted or changed, or other constituent elements are added as appropriate.

The acceleration sensor 12 as the inertial sensor measures acceleration generated in each of three-axis directions mutually intersecting (ideally orthogonal), and outputs a digital signal (acceleration data) corresponding to the measured magnitude and direction of the acceleration in the three-axis directions.

The angular velocity sensor 14 as the inertial sensor measures the angular velocity generated about the respective axes of three-axes mutually intersecting (ideally orthogonal) and outputs the digital signal (acceleration data) corresponding to the measured magnitude and direction of the acceleration in the three-axis directions.

The signal processing unit 16 receives the acceleration data and the angular velocity data from the acceleration sensor 12 and the angular velocity sensor 14, adds the time information, stores the data in a storage unit (not illustrated), generates packet data conforming to the communication format by attaching time information to the stored measurement data (acceleration data and angular velocity data), and outputs the packet data to the communication unit 18.

It is an ideal matter that the acceleration sensor 12 and the angular velocity sensor 14 are attached to the sensor unit 10 such that each three-axis coincides to the three-axes (x-axis, y-axis, and z-axis) of an orthogonal coordinate system which is defined with respect to the sensor unit 10. However, in practice, an error in the mounting angle occurs. Therefore, the signal processing unit 16 performs a process of converting the acceleration data and the angular velocity data into data in a XYZ coordinate system by using a correction parameter calculated in advance according to the mounting angle error.

Further, the signal processing unit 16 may perform temperature correction processing of the acceleration sensor 12 and the angular velocity sensor 14. Alternatively, the temperature correction function may be incorporated in the acceleration sensor 12 and the angular velocity sensor 14.

The acceleration sensor 12 and the angular velocity sensor 14 may output an analog signal. In this case, the signal processing unit 16 may generate measurement data (acceleration data and angular velocity data) by A/D converting each of the output signal of the acceleration sensor 12 and the output signal of the angular velocity sensor 14 and generate communication packet data using the measurement data.

The communication unit 18 performs a process of transmitting the packet data received from the signal processing unit 16 to the swing analyzing apparatus 20, a process of receiving various types of control commands such as a measurement start command from the swing analyzing apparatus 20 and transmitting the control commands to the signal processing unit 16. The signal processing unit 16 performs various processes according to the control command.

As illustrated in FIG. 6, the swing analyzing apparatus 20 is configured by including a processing unit 21, a communication unit 22, the operation unit 23, a storage unit 24, the display unit 25, a sound output unit 26, a communication unit 27, and the position information acquisition unit 43. However, the swing analyzing apparatus 20 may have a configuration in which some of these constituent elements are deleted or changed, or other constituent elements are added as appropriate.

The communication unit 22 performs a process of receiving packet data transmitted from the sensor unit 10 and transmitting the packet data to the processing unit 21, a process of transmitting the control command from the processing unit 21 to the sensor unit 10, or the like. In addition, the communication unit 22 performs a process of receiving course information including a course arrangement of a golf field and the like via the network 40.

The operation unit 23 acquires data according to the operation of the user 2 and performs a process of transmitting the data to the processing unit 21. The operation unit 23 may be, for example, a touch panel display, a button, a key, a microphone, or the like.

The storage unit 24 is configured by various IC memories such as a read only memory (ROM), a flash ROM, or a random access memory (RAM), or a recording medium such as a hard disk or a memory card. The storage unit 24 stores programs for the processing unit 21 to perform various calculation processes and control processes, various programs and data for realizing application functions, and the like.

In the present embodiment, the storage unit 24 stores a swing analyzing program 240 read by the processing unit 21 and for executing a swing analysis process. The swing analyzing program 240 may be stored in advance in a nonvolatile recording medium (a computer readable recording medium), or may be stored in a server (not illustrated) by the processing unit 21 via the network 40 or in the storage unit 24 by receiving the swing analyzing program 240 from the swing diagnostic device 30.

In the present embodiment, the storage unit 24 stores golf club information 242, physical information 244, sensor mounting position information 246, golf course information 247, and swing analysis data 248. For example, the user 2 operates the operation unit 23 to input specification information (for example, at least a part of information on a length of the shaft, a position of a center of gravity, an lie angle, a face angle, a loft angle, or the like) of the golf club 3 to be used, and may use the input specification information as the golf club information 242. Alternatively, in step S1 of FIG. 4, the user 2 inputs the number of the golf club 3 (or selects the number from the number list), and in the specification information of each model number stored in the storage unit 24 in advance, the user 2 inputs the inputted model number Specification information of the model number may be used as the golf club information 242.

In addition, for example, the user 2 operates the operation unit 23 and inputs the physical information from the input screen, and may use the input physical information as the physical information 244. In addition, for example, in step S1 of FIG. 4, the user 2 operates the operation unit 23, and inputs a distance between a mounting position of the sensor unit 10 and a grip end of the golf club 3, and may uses the input distance information as the sensor mounting position information 246. Alternatively, the sensor unit 10 may be stored in advance as a unit to be mounted at a predetermined position (for example, a distance of 20 cm from the grip end), and the information of the predetermined position may be stored in advance as the sensor mounting position information 246. In addition, the user 2 operates the operation unit 23 and may store the information of the playing golf field as the golf course information 247 in advance via the network 40.

The swing analysis data 248 includes a time (day and time) when the swing is performed, identification information or the gender of the user 2, the types of the golf club 3, and information on the analysis result of the swing operation by the processing unit 21 (swing analyzing unit 211).

In addition, the storage unit 24 is used as a work area of the processing unit 21, and temporarily stores data acquired by the operation unit 23, operation results executed by the processing unit 21 according to various programs, and the like. Furthermore, the storage unit 24 may store data requiring long-term storage, among the data items generated by the processing of the processing unit 21.

The display unit 25 displays the processing result of the processing unit 21 as characters, graphs, tables, animations, and other images. The display unit 25 may be, for example, a CRT, an LCD, the touch panel display, a head mounted display (HMD), or the like. The functions of the operation unit 23 and the display unit 25 may be realized by a single touch panel display.

It is preferable that first analysis information to be displayed on the display unit 25 may include information relating to at least one of an impact based on a relative face angle and a club path (an incident angle), an efficiency based on a deceleration amount and a timing in the grip of the golf club 3, a rotation based on a rotation angle and the face angle of the shaft axis at the top, a head speed based on the speed of the golf club 3 at the time of hitting the ball, and a swing pace based on the timing of address start, swing start, top, and impact. As the analysis data of the important index indicating ability (level) with respect to the plurality of swings is not limited to the above-described data, and an index such as a hand-up based on lie angle at the time when hitting the ball and the address or a down-blow based on a face angle and an attack angle may be included.

Accordingly, the user 2 can obtain information relating to at least one of the impact, the V zone, the efficiency, the rotation, the head speed, and the swing pace as the analysis data of the importance index indicating uses the information on at least one of the impact, the V zone, the efficiency, the rotation, the head speed, and the tempo of the swing as detailed data as analysis data of an important index indicating the ability (level) with respect to the plurality of swings, as detailed data.

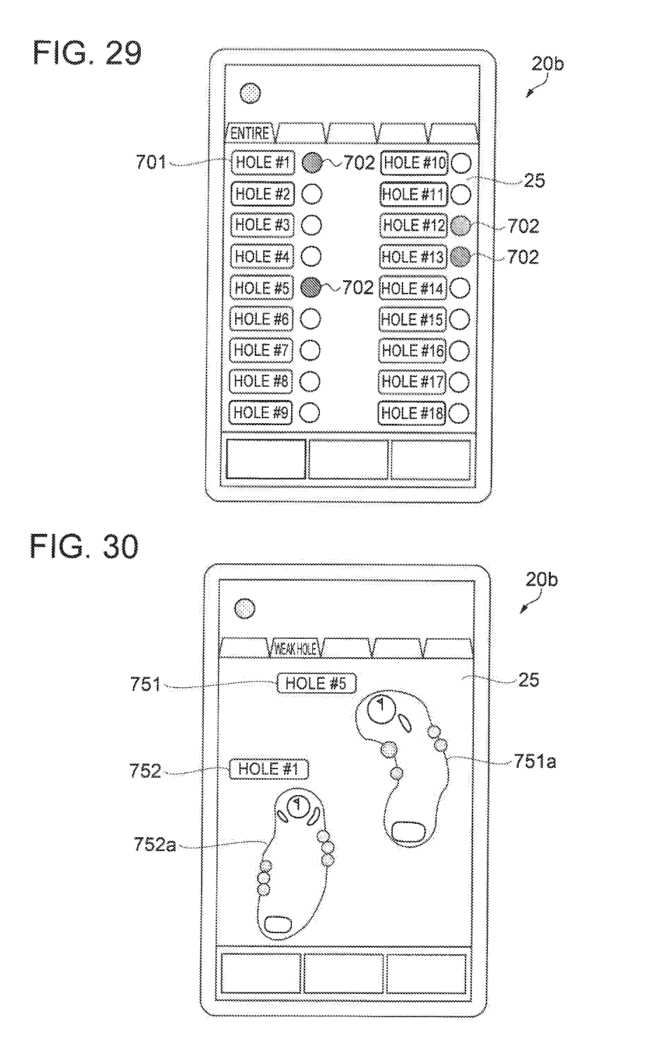

For example, the display unit 25 displays an image as illustrated in Display Example 1 in FIG. 29 to Display Example 6 in FIG. 34, and the like. Since the detailed display examples will be described later, the description here will be omitted. In addition, as a function of the operation unit 23 in the display unit 25, display contents can be switched or enlarged and reduced by touching the display unit 25 (screen touch) or the like.

The sound output unit 26 outputs the processing result (analysis information) of the processing unit 21 for presentation the result as sound information such as sound or buzzer sound. The sound output unit 26 may be, for example, a speaker, a buzzer, or the like.

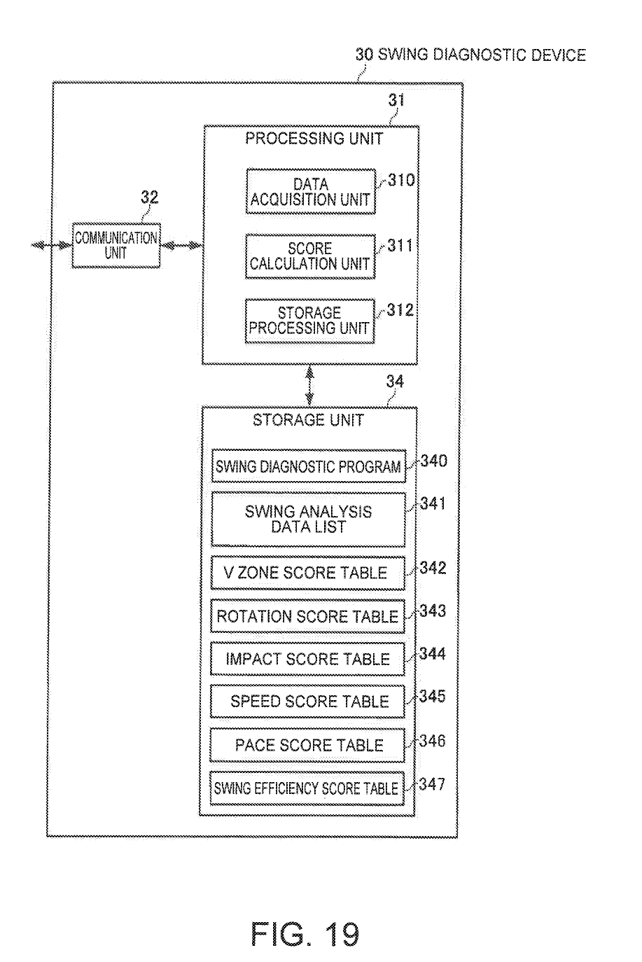

The communication unit 27 performs data communication with a communication unit 32 (see FIG. 19) of the swing diagnostic device 30 via the network 40. For example, after finishing the swing analysis process, the communication unit 27 receives the swing analysis data 248 from the processing unit 21 and performs a process of transmitting the data to the communication unit 32 of the swing diagnostic device 30. In addition, for example, the communication unit 27 performs a process of receiving the information required for displaying the selection screen from the communication unit 32 of the swing diagnostic device 30 and transmitting the information to the processing unit 21 or a process of receiving the information selected in the selection screen from the processing unit 21 and transmitting the information to the communication unit 32 of the swing diagnostic device 30. In addition, for example, the communication unit 27 performs a process of receiving the information required for displaying the input data editing screen from the communication unit 32 of the swing diagnostic device 30 and transmitting the information to the processing unit 21. In addition, for example, the communication unit 27 performs a process of receiving input data when a diagnosis start button in the input data editing screen is pressed from the processing unit 21 and transmitting the data to the communication unit 32 of the swing diagnostic device 30. In addition, for example, the communication unit 27 performs a process of receiving the information required for displaying a swing diagnosis screen (information of the diagnosis result based on the input data (a score of a plurality of items or a total point)) from the communication unit 32 of the swing diagnostic device 30 and transmitting the information to the processing unit 21.

The processing unit 21 as an output unit performs a process of transmitting a control command to the sensor unit 10 via the communication unit 22 in accordance with various types of programs and various kinds of calculation processes on data received from the sensor unit 10 via the communication unit 22. In addition, the processing unit 21 performs a process of reading the swing analysis data 248 from the storage unit 24 in accordance with the various types of programs and transmitting the data to the swing diagnostic device 30 via the communication unit 27. In addition, in the swing analyzing unit 211, the processing unit 21 detects swing which is deviated from the predetermined range among the numerical values which are obtained by quantifying the motion state to the plurality of swings of the golf by a processing unit 31 of the swing diagnostic device 30 as a computation unit to be described and obtains a play state indicating an actual state of an operation including the golf swing, movement and the like of the user 2, a strong point, and a weak point from the detection result in the plurality of swings. The processing unit 21 can output the obtained play state of the user 2 as image data corresponding to the image indicating the play state (for example, see FIGS. 29 to 34). In addition, the processing unit 21 can transmit various types of information items to the swing diagnostic device 30 via the communication unit 27 in accordance with the various types of programs, obtain the play state of the user 2 based on the information received from the swing diagnostic device 30, and output the play state of the user 2 as the image data corresponding to the image indicating the play state.

In addition, the processing unit 21 can cause the storage unit 24 to store, the course arrangement and altitude of the golf field input via the communication unit 22, as the golf course information 247. In addition, the processing unit 21 calculates position information of the user 2 based on current position data transmitted from the position information acquisition unit 43 to be described. The position information includes information such as a movement trajectory and a movement time (a staying time) in the course of the user 2. The processing unit 21 can output the play state of the user 2 as the image data corresponding to the image indicating the play state (for example, see FIGS. 29 to 34) from the calculated position information of the user 2 and the detection result of the above-described plurality of swings. In this manner, since the play state is output with a combination of the calculated position information of the user 2 and the detection result of the motion state in the golf swing, it is possible to more precisely perform the output in the play state including the movement state of the user 2. In addition, the processing unit 21 performs the other various types of control processes.

By executing the swing analyzing program 240, the processing unit 21 serves as a data acquisition unit 210, the swing analyzing unit 211, an image data generation unit 212, a storage processing unit 213, a display processing unit 214, and a sound output processing unit 215. The processing unit 21 serves as a computer.

In particular, in the present embodiment, by executing the swing analyzing program 240, the processing unit 21 serves as the data acquisition unit 210, the swing analyzing unit 211, the image data generation unit 212, the storage processing unit 213, the display processing unit 214, and the sound output processing unit 215. The processing unit 21 performs a process of analyzing the swing operation of the user 2 (a swing analyzing process) or a process of obtaining and outputting the play state indicating the actual state of the operation including the golf swing, movement and the like of the user 2, the strong point, and the weak point.

The data acquisition unit 210 performs a process of receiving the packet data received from the sensor unit 10 through the communication unit 22, acquiring the time information and the measurement data from the received packet data, and transmitting the data to the storage processing unit 213. In addition, the data acquisition unit 210 performs a process of receiving the information required for displaying various types of screens received from the swing diagnostic device 30 through the communication unit 27 and transmitting the information to the image data generation unit 212.

The storage processing unit 213 performs a read and write process of various types of program or various types of data items with respect to the storage unit 24. For example, the storage processing unit 213 performs a process of associating the time information and the measurement data received from the data acquisition unit 210 and storing the associated information and the data in the storage unit 24 or a process of storing the various types of information items calculated by the swing analyzing unit 211 or the swing analysis data 248 to the storage unit 24.

The swing analyzing unit 211 performs a process of analyzing the swing operation (the plurality of swings) of the user 2 using the measurement data (measurement data stored in the storage unit 24) which is output by the sensor unit 10 or the data from the operation unit 23, and generating the swing analysis data 248 as the first analysis information including information items of a time (day and time) at which the swing is performed, the identification information and gender of the user 2, the type of the golf club 3, and the analysis result of the swing operation. In particular, in the present embodiment, the swing analyzing unit 211 calculates the value of each index of the golf swing as at least a part of the information of the analysis result of the swing operation. The swing analysis data 248 as the first analysis information includes at least one of the impact, the V zone, the efficiency (the swing efficiency), the rotation, the head speed, and the swing pace.

The swing analyzing unit 211 may calculate at least one virtual plane as the index of swing. For example, the at least one virtual plane includes a shaft plane SP (a first virtual plane) to be described and Hogan's plane HP (a second virtual plane) forming a predetermined angle with the shaft plane SP. The swing analyzing unit 211 may calculate the “shaft plane SP” and the “Hogan's plane HP” as the index.

In addition, the swing analyzing unit 211 may calculate the position of the head 3a of the golf club 3 at a first timing during the backswing as an index of the swing. For example, the first timing is a halfway back in which the longitudinal direction of the golf club 3 is along the horizontal direction during the backswing, and as the index, the swing analyzing unit 211 may calculate “the position of the head 3a during the halfway back” to be described.

In addition, as the index of the swing, the swing analyzing unit 211 may calculate the position of the head 3a of the golf club 3 at a second timing during the downswing. For example, the second timing is a halfway down in which the longitudinal direction of the golf club 3 is along the horizontal direction during the downswing, and as the index, the swing analyzing unit 211 may calculate “the position of the head 3a during the halfway down” to be described.

In addition, as the index of the swing, the swing analyzing unit 211 may calculate the index based on the incident angle of the head 3a of the golf club 3 in the impact (when hitting the ball). For example, as the index, the swing analyzing unit 211 may calculate “a club path (the incident angle) ψ”.

In addition, as the index of the swing, the swing analyzing unit 211 may calculate the index based on the direction of the head 3a of the golf club 3 in the impact (when hitting the ball).

In addition, as the index of the swing, the swing analyzing unit 211 may calculate the index based on the speed of the golf club 3 (the head 3a) in the impact (when hitting the ball). For example, as the index, the swing analyzing unit 211 may calculate “a head speed” to be described.

In addition, as the index of the swing, the swing analyzing unit 211 may calculate the index based on a rotation angle around the rotation axis of the shaft of the golf club 3 (hereinafter, referred to as the longitudinal axis) at a predetermined timing from the start of the backswing to the impact (when hitting the ball with the longitudinal direction of the shaft as the rotation axis. The rotation angle about the longitudinal axis of the golf club 3 may be an angle at which the golf club 3 is rotated about the longitudinal axis from a reference timing to the predetermined timing. The reference timing may be at the start of the backswing or at the time of the address. In addition, the predetermined timing may be the time of moving from the backswing to the downswing (at the top). For example, as the index, the swing analyzing unit 211 may calculate “a shaft axis rotation angle θₜₒₚ at the top” to be described later.

In addition, as the index of the swing, the swing analyzing unit 211 may calculate the index based on a deceleration amount of the grip of the golf club 3 in the downswing. For example, as the index, the swing analyzing unit 211 may calculate a “grip deceleration rate Rv” to be described. The “grip deceleration rate Rv” is also referred to as “natural uncock” or a “natural uncock rate”.

In addition, as the index of the swing, the swing analyzing unit 211 may calculate the index based on a deceleration period of the grip of the golf club 3 in the downswing. For example, as the index, the swing analyzing unit 211 may calculate a “grip deceleration time rate R_{T}” to be described.

As the index of the swing, the swing analyzing unit 211 may calculate the index based on the deceleration timing of the grip of the golf club 3 in the downswing. For example, as the index, the swing analyzing unit 211 may calculate the timing (a “natural release timing”) of the natural uncock, which is the timing of the movement of the head 3a of the golf club 3 to be accelerated by decreasing the speed of the golf club 3 at the grip side. The timing of natural uncock is an index indicating the timing at which an energy accumulated at the top swing switches to release and the timing of switching in a state of being transmitted to the golf club 3.

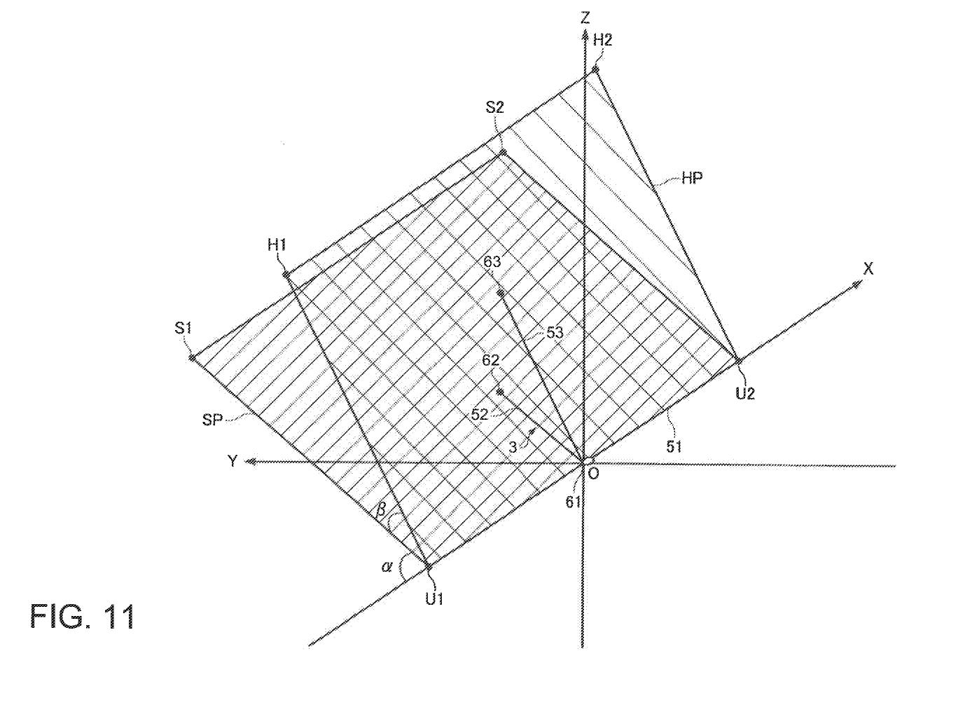

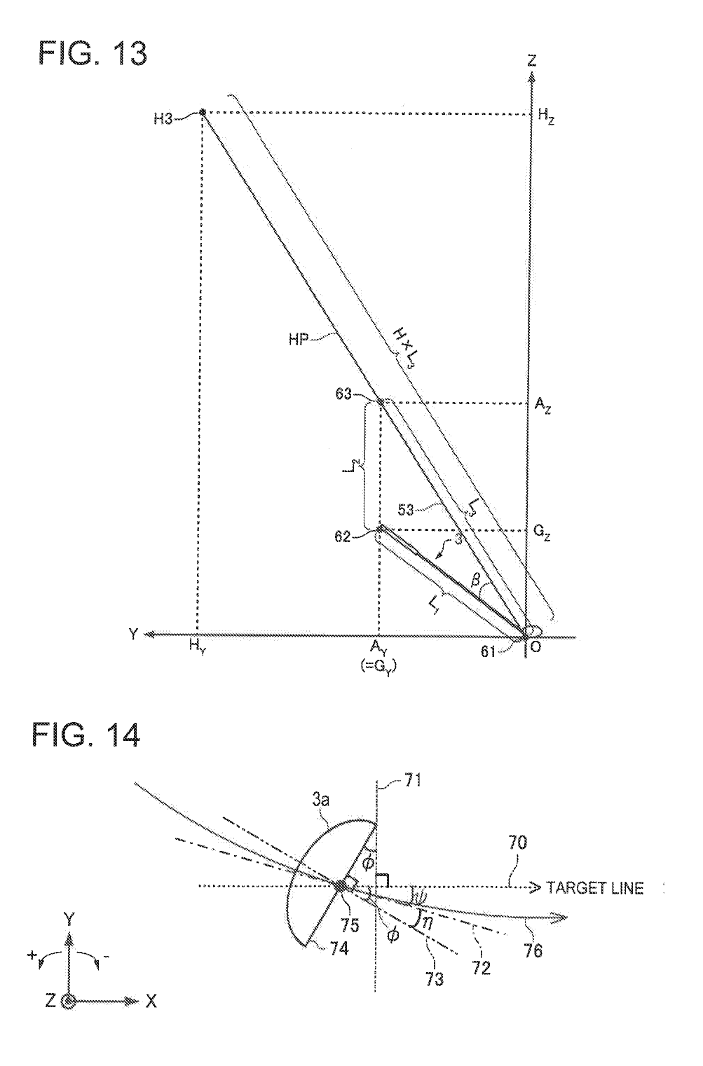

In addition, as the index of the swing, the swing analyzing unit 211 may calculate an index related to the position of the head 3a at the time of halfway back (HWB) and an index related to the position of the head 3a at the time of halfway down (HWD) in a region sandwiched between a shaft plane SP (the first virtual plane) called “V zone” and the Hogan's plane HP (the second virtual plane) (see FIGS. 11 and 13).

In addition, as the index of the swing, the swing analyzing unit 211 may calculate the index based on the lie angle at the time of hitting the ball and the lie angle at the time of address in the head 3a of the golf club 3.

In addition, as the index of the swing, the swing analyzing unit 211 may calculate the index based on the “face angle” and the “attack angle” in the head 3a of the golf club 3.

However, the swing analyzing unit 211 may not calculate a part of the value of these indices or may calculate other index values, as appropriate.

The image data generation unit 212 performs a process of generating image data corresponding to the image displayed on the display unit 25. For example, the image data generation unit 212 generates the image data corresponding to the selection screen, the input data editing screen, the swing diagnosis screen based on the various types of information items received by the data acquisition unit 210.

The display processing unit 214 performs a process of displaying various types of images (including not only images corresponding to the image data generated by the image data generation unit 212 but also characters, symbols, and the like) on the display unit 25. For example, the display processing unit 214 causes the display unit 25 to display the selection screen, the input data editing screen, the swing diagnosis screen, and the like, based on the image data generated by the image data generation unit 212. In addition, for example, in step S5 of FIG. 4, the image data generation unit 212 may allow the user 2 to display the images or the characters for notifying a permission of starting the swing on the display unit 25. In addition, for example, after finishing the swing operation of the user 2, the display processing unit 214 may cause the display unit 25 to display text information such as the characters or symbols indicating the analysis result by the swing analyzing unit 211 automatically or according the input operation of the user 2. Alternatively, after providing the display unit in the sensor unit 10, the display processing unit 214 may transmit the image data to the sensor unit 10 via the communication unit 22 and cause the display unit of the sensor unit 10 to display various types of the images or characters.

The sound output processing unit 215 performs a process of outputting various types of sounds (including a voice, a buzzer sound, or the like) to the sound output unit 26. For example, in step S5 of FIG. 4, the sound output processing unit 215 may output a sound for notifying the user 2 of the permission of starting the swing from the sound output unit 26. In addition, for example, after finishing the swing operation of the user 2, the sound output processing unit 215 may cause the sound output unit 26 to output the sound or the voice indicating the analysis result by the swing analyzing unit 211 automatically or according the input operation of the user 2. Alternatively, after providing a sound output unit in the sensor unit 10, the sound output processing unit 215 may transmit various types of sound data items or voice data items to the sensor unit 10 via the communication unit 22 and cause the sound output unit of the sensor unit 10 to output various types of sounds or voices.

After providing a vibration mechanism in the swing analyzing apparatus 20 or the sensor unit 10, various types of information items may be converted into vibration information by the vibration mechanism and notified to the user 2.

The position information acquisition unit 43 receives the position information included in a radio wave (a satellite signal) from the GPS satellite 8 as a position information output unit, performs the positioning calculation (acquisition of the position information), and acquires (calculates) the current position data of the swing analyzing apparatus 20. The position information acquisition unit 43 outputs the obtained current position data to the processing unit 21.

### 1-3. Swing Analyzing Process

In the present embodiment, the position of the head 3a of the golf club 3 at the time of address (during rest) is set as an origin, the XYZ coordinate system (a global coordinate system) in which the target line indicating a target direction of hitting the ball is defined as the X-axis, the axis on the horizontal plane vertical to the X-axis is defined as the Y-axis, and the vertically upward direction (direction opposite to the direction of the gravitational acceleration) is defined as the Z-axis is defined. Since the swing analyzing unit 211 calculates each index value, the swing analyzing unit 211 calculates the position and the posture of the sensor unit 10 after the time of address in the XYZ coordinate system (the global coordinate system) using the measurement data (the acceleration data and the angular velocity data) of the sensor unit 10 in time series. In addition, the swing analyzing unit 211 detects each timing of the swing start, the top, and impact which are illustrated in FIG. 5 using the measurement data (the acceleration data and the angular velocity data) of the sensor unit 10. The swing analyzing unit 211 calculates the value of each index of the swing (for example, the V zone, the efficiency (the swing efficiency), the rotation, the impact, the swing pace, or the like) using the time series data of the position and the posture of the sensor unit 10 and each timing of the swing start, the top and the impact, and generates the swing analysis data 248.

### 1-3-1. Calculation of Position and Posture of Sensor Unit 10

When the user 2 performs the operation of step S4 of FIG. 4, firstly, in a case where an amount of change in the acceleration data measured by the acceleration sensor 12 continues not exceeding a threshold for a predetermined time, the swing analyzing unit 211 determines that the user 2 stands still at the address posture. Next, the swing analyzing unit 211 calculates an offset amount included in the measurement data by using the measurement data (the acceleration data and the angular velocity data) within the predetermined time. Next, the swing analyzing unit 211 subtracts the offset amount from the measurement data to correct a bias, and calculates the position and the posture of the sensor unit 10 during swing operation of the user 2 (during operation in step S6 of FIG. 4) using the bias-corrected measurement data.

In particular, firstly, the swing analyzing unit 211 calculates the position (an initial position) of the sensor unit 10 at the time when the user 2 stands still (at the time when address) in the XYZ coordinate system (the global coordinate system) using the acceleration data, the golf club information 242, and the sensor mounting position information 246 measured by the acceleration sensor 12.

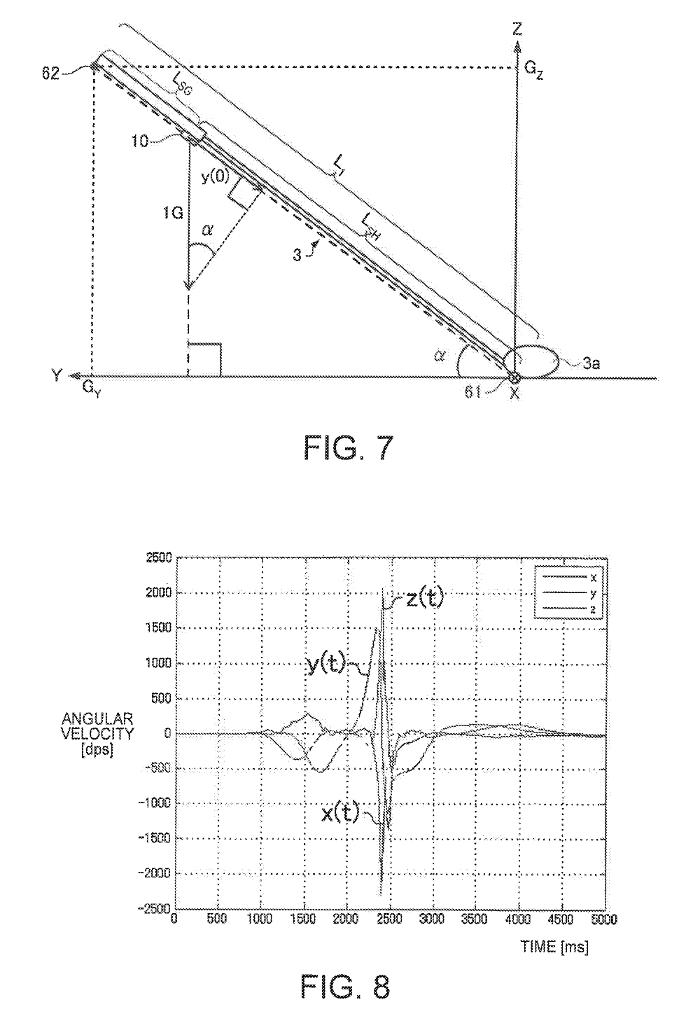

FIG. 7 is a plan view of the golf club 3 and the sensor unit 10 viewed from a negative side of an X-axis at the time when a user 2 stands still (at the time when address). A position 61 of the head 3a of the golf club 3 becomes an origin O (0, 0, 0), and a coordinate of a grip end position 62 is (0, G_{y}, G_{z}). Since the user 2 performs the operation in step S4 of FIG. 4, an X-coordinate of the grip end position 62 or the initial position of the sensor unit 10 is 0, and the position exists on a YZ plane. As illustrated in FIG. 7, since gravity acceleration 1G is applied to the sensor unit 10 at the time when the user 2 stands still, a relationship between y-axis acceleration y(0) to be measured by the sensor unit 10 and an inclination angle of the shaft of the golf club 3 (an angle formed by the longitudinal direction of the shaft and the horizontal plane (XY plane)) a is represented by Equation (1).

y(0)=1G·sin α (1)

Accordingly, the swing analyzing unit 211 can calculate the inclination angle α by Equation (1) using arbitrary acceleration data within an arbitrary time at the time when address (at the time when the user stands still).

Next, the swing analyzing unit 211 subtracts a distance L_{SG} between the sensor unit 10 and the grip end position 62 included in the sensor mounting position information 246 from a length L₁ of the shaft included in the golf club information 242 to obtain a distance L_{SH} between the sensor unit 10 and the head 3a. Furthermore, the swing analyzing unit 211 sets the position of the distance L_{SH} from the position 61 (the origin O) of the head 3a in a direction specified by the inclination angle α of the shaft (the negative direction of the y-axis of the sensor unit 10) to the position of the sensor unit 10.

The swing analyzing unit 211 integrates the subsequent acceleration data and calculates the coordinates of the position moved from the initial position of the sensor unit 10 in time series.

In addition, the swing analyzing unit 211 calculates the posture (an initial posture) of the sensor unit 10 at the time when the user 2 stands still (at the time when address) in the XYZ coordinate system (the global coordinate system) using the acceleration data measured by the acceleration sensor 12. Since the user 2 performs the operation in step S4 in FIG. 4, since the x-axis of the sensor unit 10 coincides with the X-axis of the XYZ coordinate system at the time of address of the user 2 (at the time when the user stands still) and the y-axis of the sensor unit 10 is on the YZ plane, the swing analyzing unit 211 can specify the initial posture of the sensor unit 10 by the inclination angle α of the shaft of the golf club 3.

The swing analyzing unit 211 performs a rotation operation using the angular velocity data measured by the angular velocity sensor 14, and calculates the change in the posture from the initial posture of the sensor unit 10 in time series. The posture of the sensor unit 10 can be represented by, for example, the rotation angle (a roll angle, a pitch angle, and a yaw angle) about the X-axis, the Y-axis, and the Z-axis, a quaternion (quaternion), or the like.

The signal processing unit 16 of the sensor unit 10 may calculate the offset amount of the measurement data and performs the bias correction of the measurement data. The function of the bias correction may be incorporated in the acceleration sensor 12 and the angular velocity sensor 14. In these cases, the bias correction of the measurement data by the swing analysis unit 211 becomes unnecessary.

### 1-3-2. Detection of Timing of Swing Start, Top, and Impact

Firstly, the swing analyzing unit 211 detects the timing (the timing of the impact) when the user 2 hits the ball using the measurement data. For example, the swing analyzing unit 211 may calculate a composite value of the measurement data (the acceleration data and the angular velocity data) and detect the timing of the impact based on the composite value.

In particular, firstly, the swing analyzing unit 211 calculates a value of a composite value n₀ (t) of the angular velocity at each time t using the angular velocity data (bias-corrected angular velocity data for each time t). For example, when the angular velocity data items at the time t are defined as x (t), y (t), and z (t), the swing analyzing unit 211 calculates the composite n₀ (t) of the angular velocity by Equation (2) below.

n₀(t)=\sqrt{x(t)²+y(t)²+z(t)²} (2)

Next, the swing analyzing unit 211 converts the composite value n₀ (t) of the angular velocity at each time t into the synthesized value n (t) normalized (the scale conversion) to a predetermined range. For example, when a maximum value of the composite value of the angular velocity in an acquisition period of the measurement data is defined as max (n₀), the swing analyzing unit 211 converts the composite value n₀ (t) of the angular velocity into a composite value n (t) normalized to a range of 0 to 100 by Equation (3) below.

$$n ( t ) = \frac{100 \times {n}_{0} ( t )}{max ( {n}_{0} )} \qquad ( 3 )$$

Next, the swing analyzing unit 211 calculates the differential dn (t) of the normalized composite value n (t) at each time t. For example, when the measurement period of the three-axis angular velocity data is defined as Δt, the swing analyzing unit 211 calculates the differential (difference) dn (t) of the composite value of angular velocity at time t by Equation (4) below.

dn(t)=n(t)−n(t−Δt) (4)

FIG. 8 illustrates an example of three-axial angular velocity data items x (t), y (t), z (t) when the user 2 swings and hits the golf ball 4. In FIG. 8, the horizontal axis represents the time (msec) and the vertical axis represents the angular velocity (dps).

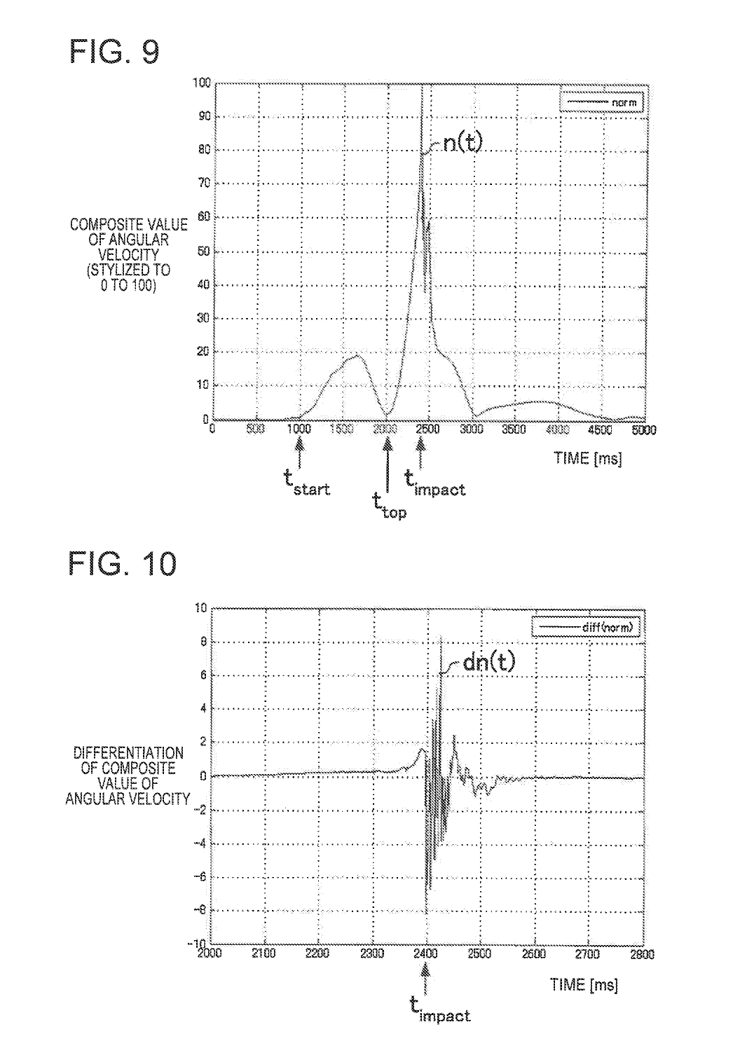

FIG. 9 is a graphical representation of the composite value n (t) normalized to 0 to 100 according to Equation (3) after calculating the composite value n₀ of the three-axis angular velocity from the three-axis angular velocity data items x (t), y (t), and z (t) of FIG. 8 according to Equation (2). In FIG. 9, the horizontal axis represents the time (msec) and the vertical axis represents the composite value of the angular velocity.

FIG. 10 is a graph showing the differential dn (t) calculated from the composite value n (t) of the three-axial angular velocity of FIG. 9 according to Equation (4) and displayed in a graph. In FIG. 10, the horizontal axis represents the time (msec) and the vertical axis represents a differential value of the composite value of the three-axial angular velocity. In FIG. 8 and FIG. 9, the horizontal axis is displayed in 0 to 5 seconds. However, in FIG. 10, the horizontal axis is displayed in 2 to 2.8 seconds so that the change in the differential value before and after the impact is known.

Next, the swing analyzing unit 211 detects the earlier time of the time among the time at which the differential value dn (t) of the composite value becomes maximum and the time at the differential value dn (t) of the composite value becomes minimum, as the time of impact t_{impact} (impact timing). In a normal golf swing, it is considered that the swing speed will be the maximum at the moment of impact. Since it can be considered that the value of the composite value of the angular velocity is changed according to the swing speed, the swing analyzing unit 211 can recognize the timing (that is, the timing at which the differential value of the composite value of the angular velocity becomes the positive maximum value or the negative minimum value) at which the differential value of the composite value of the angular velocity becomes the maximum or minimum among the series of swing operations as the impact timing. Since the impact causes the golf club 3 to vibrate, it is considered that the timing at which the differential value of the composite value of the angular velocity becomes the maximum and the timing at which the differential value of the composite value of the angular velocity becomes the maximum occur in pairs. However, it is considered that the earlier timing among the timings is the impact moment.

Next, the swing analyzing unit 211 detects the time of the minimum point at which the composite value n (t) approaches 0 before the impact time t_{impact} as the top time tₜₒₚ (top timing) (see FIG. 9). In a normal golf swing, it is considered that the swing starts, and the operation stops once at the top, thereafter the swing speed gradually increases to impact. Therefore, the swing analyzing unit 211 can recognize the timing at which the composite value of the angular velocity before the impact timing approaches 0 and becomes minimum, as the top timing.

Next, the swing analyzing unit 211 sets a section in which the composite value n (t) is equal to or less than a predetermined threshold before and after the top time tₜₒₚ as a top section, and the latest time in which the composition value n(t) is equal to or less than a predetermined threshold before the start time of the top section as the time tₛₜₐᵣₜ of the swing start (backswing start) (see FIG. 9). In the normal golf swing, it is unlikely that the swing operation will start from a stationary state and the swing operation will stop until the top. Therefore, the swing analyzing unit 211 can recognize the final timing at which the composite value of the angular velocity before the top section becomes a predetermined threshold or less as the start timing of the swing operation. The swing analyzing unit 211 may detect the time of the minimum point at which the composite value n (t) approaches 0 (zero) before the top time tₜₒₚ as the time tₛₜₐᵣₜ of the swing start.

The swing analyzing unit 211 can similarly detect each timing of the swing start, the top, and the impact, even by using the three-axis acceleration data.

### 1-3-3. Calculation of Shaft Plane and Hogan's Plane

The shaft plane is a first virtual plane specified by the target line (the target direction of hitting the ball) and the longitudinal direction of the shaft of the golf club 3 at the time of address (a stationary state) before the start of the swing of the user 2. In addition, the Hogan's plane is a second virtual plane specified by a virtual line connecting a shoulder of the user 2 (the shoulder or a base of the neck) and the head 3a (or the golf ball 4) of the golf club, and the target line (the target direction of the hitting the ball).

FIG. 11 is a diagram illustrating the shaft plane and the Hogan's plane. In FIG. 11, the X-axis, the Y-axis, and the Z-axis of the XYZ coordinate system (the global coordinate system) are also denoted.

As illustrated in FIG. 11, in the present embodiment, a virtual plane including a first line segment 51 as a first axis along the target direction of hitting the ball and a second line segment 52 as a second axis along the longitudinal direction of the shaft of the golf club 3 and having U1, U2, S1, and S2 as four apexes is defined as the shaft plane SP (the first virtual plane). In the present embodiment, the position 61 of the head 3a of the golf club 3 at the time when address is defined as an origin O (0, 0, 0) of the XYZ coordinate system, and the second line segment 52 is a line segment connecting the position 61 (the origin O) of the head 3a of the golf club 3 and the grip end position 62. In addition, the first line segment 51 is a line segment having U1 and U2 on the X-axis as both ends and the origin O as the midpoint. Since the shaft of the golf club 3 is perpendicular to the target line (the X-axis) by the user 2 performing the operation of step S4 of FIG. 4 at the time when address, the first line segment 51 is a line segment orthogonal to the longitudinal direction of the shaft of the golf club 3, that is, a line segment orthogonal to the second line segment 52. The swing analyzing unit 211 calculates the coordinates of the four apexes U1, U2, S1, and S2 in the XYZ coordinate system as the shaft plane SP.

In particular, firstly, the swing analyzing unit 211 calculates coordinates (0, G_{Y}, G_{Z}) of the grip end position 62 of the golf club 3 using the inclination angle α and the length L₁ of the shaft included in the golf club information 242. As illustrated in FIG. 7, the swing analyzing unit 211 can calculate G_{Y} and G_{Z} by using the length L₁ of the shaft and the inclination angle α, respectively, according to Equations (5) and (6).

G_{Y}=L₁·cos α (5)

G_{Z}=L₁·sin α (6)

Next, the swing analyzing unit 211 multiplies the coordinates (0, G_{Y}, G_{Z}) of the grip end position 62 of the golf club 3 by a scale factor S and calculates coordinates (0, S_{Y}, S_{Z}) of a midpoint S3 between an apex S1 and an apex S2 of the shaft plane SP. That is, the swing analyzing unit 211 calculates S_{Y} and S_{Z} respectively by Equations (7) and (8).

S_{Y}=G_{Y}·S (7)

S_{Z}=G_{Z}·S (8)

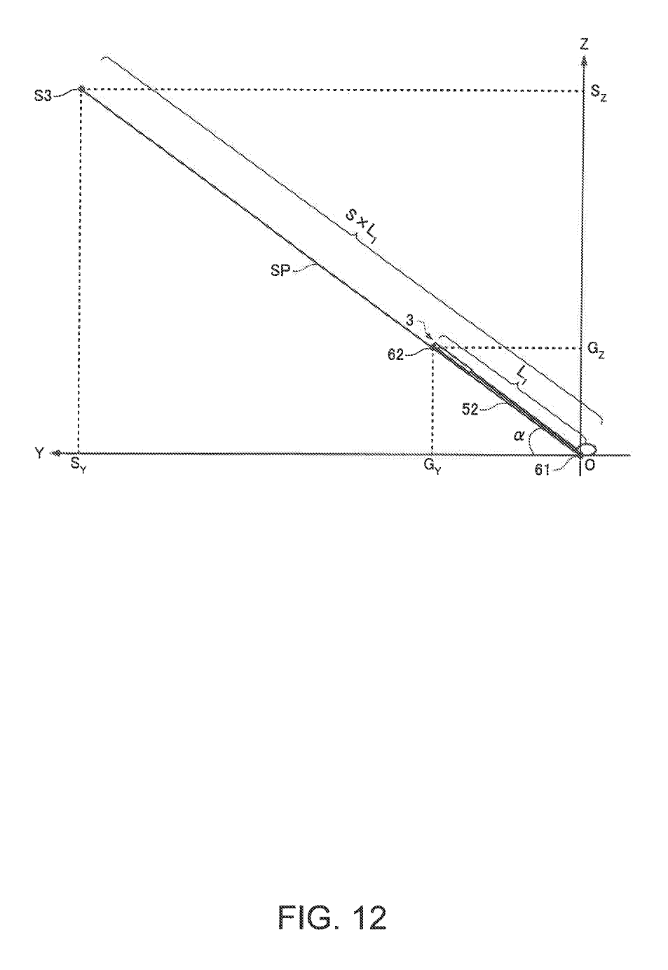

FIG. 12 is a diagram of the shaft plane SP of FIG. 11 cut along an YZ plane as viewed from the negative side of the X-axis. As illustrated in FIG. 12, the length of the line segment connecting the midpoint S3 between the apex S1 and the apex S2 to the origin O (the width in the direction orthogonal to the X-axis of the shaft plane SP) is S times the length L₁ of the second line segment 52. This scale factor S is set to a value such that the trajectory of the golf club 3 during the swing operation of the user 2 falls within in the shaft plane SP. For example, when the length of the arm of the user 2 is defined as L₂ (see FIG. 13), the scale factor S may be set as in Equation (9) so that a width S×L₁ in the direction perpendicular to the X-axis of the shaft plane SP is twice the sum of the length L₁ of the shaft and the length L₂ of the arm is twice as large as the scale factor S.

$$S = \frac{2 \cdot ( {L}_{1} + {L}_{2} )}{{L}_{1}} \qquad ( 9 )$$

In addition, the length L₂ of the arm of the user 2 has a correlation with the height L₀ of the user 2, and in a case where the user 2 is a male, for example, it is expressed by a correlation formula such as Equation (10) based on statistical information, and in a case where the user 2 is a female, it is expressed by a correlation formula such as Equation (11).

L₂=0.41×L₀−45.5 [mm] (10)

L₂=0.46×L₀−126.9 [mm] (11)

Accordingly, the swing analyzing unit 211 can calculate the length L₂ of the arm of the user 2 using the height L₀ of the user 2 included in the physical information 244 and the gender according to Equation (10) or (11).

Next, the swing analyzing unit 211 calculates coordinates (−UL/2, 0, 0) of the apex U1 of the shaft plane SP, coordinates (UL/2, 0, 0) of the apex U2, coordinates (−UL/2, S_{Y}, S_{Z}) of the apex S1, and coordinates (UL/2, S_{Y}, S_{Z}) of the apex S2 using the coordinates (0, S_{Y}, S_{Z}) of the midpoint S3 and the width of the shaft plane SP in the X-axis direction (the length of the first line segment 51). A width UL in the X-axis direction is set to a value such that the trajectory of the golf club 3 during the swing operation of the user 2 falls within the shaft plane SP. For example, the width UL in the X-axis direction may be set equal to the width S×L₁ in the direction orthogonal to the X-axis, that is, twice the sum of the length L₁ of the shaft and the length L₂ of the arm.

In this manner, the swing analyzing unit 211 can calculate the coordinates of the four apexes U1, U2, S1, and S2 of the shaft plane SP.

In addition, as illustrated in FIG. 11, in the present embodiment, a virtual plane including the first line segment 51 as the first axis and a third line segment 53 as a third axis and having U1, U2, H1, and H2 as four apexes is defined as the Hogan's plane HP (the second virtual plane). The third line segment 53 is a line segment connecting a predetermined position 63 near the line segment connecting both shoulders of the user 2 and the position 61 of the head 3a of the golf club 3. However, the third line segment 53 may be a line segment connecting the predetermined position 63 and the position of the golf ball 4. The swing analyzing unit 211 calculates coordinates of four apexes U1, U2, H1, and H2 in the XYZ coordinate system as the Hogan's plane HP.

In particular, firstly, the swing analyzing unit 211 estimates the predetermined position 63 using the coordinates (0, G_{y}, G_{z}) of the grip end position 62 of the golf club 3 at the time when address (at the time when the user stands still) and the length of the arm L₂ of the user 2 based on the physical information 244 and calculates the coordinates (A_{X}, A_{Y}, A_{Z}).

FIG. 13 is a diagram of the Hogan's plane HP of FIG. 11 cut along the YZ plane as viewed from the negative side of the X-axis. In FIG. 13, the midpoint of the line segment connecting both shoulders of the user 2 is set as the predetermined position 63, and the predetermined position 63 exists on the YZ plane. Therefore, an X coordinate A_{X} of the predetermined position 63 is 0. As illustrated in FIG. 13, the swing analyzing unit 211 estimates that the position at which the grip end position 62 of the golf club 3 is moved by the length L₂ of the arm of the user 2 in the positive direction of the Z-axis is the predetermined position 63. Therefore, the swing analyzing unit 211 sets the Y coordinate A_{Y} of the predetermined position 63 to the same value as the Y coordinate G_{Y} of the grip end position 62. In addition, the swing analysis unit 211 calculates the Z coordinate A_{Z} of the predetermined position 63 as the sum of the Z coordinate G_{Z} of the grip end position 62 and the arm length L₂ of the user 2 as illustrated in Equation (12).

A_{Z}=G_{Z}+L₂ (12)

Next, the swing analyzing unit 211 multiplies the Y coordinate A_{Y} and the Z coordinate A_{Z} of the predetermined position 63 by a scale factor H, and calculates coordinates (0, H_{Y}, H_{Z}) of a middle point H3 between the apex H1 and the apex H2 of the Hogan's plane HP. That is, the swing analyzing unit 211 calculates H_{Y} and H_{Z} respectively by Equations (13) and (14).

H_{Y}=A_{Y}·H (13)

H_{Z}=A_{Z}·H (14)

As illustrated in FIG. 13, the length of the line segment connecting the midpoint H3 between the apex H1 and the apex H2 to the origin O (the width in the direction orthogonal to the X-axis of the Hogan's plane HP) is H times the length L₃ of the third line segment 53. This scale factor H is set to a value such that the trajectory of the golf club 3 during the swing operation of the user 2 falls within in the Hogan's plane HP. For example, the Hogan's plane HP may have the same shape and size as the shaft plane SP. In this case, a width H×L₃ in the direction perpendicular to the X-axis of the Hogan's plane HP is identical to the width S×L₁ in the direction perpendicular to the X-axis of the shaft plane SP and it twice the sum of the length L₁ of the shaft of the golf club 3 and the length L₂ of the arm of the user 2. Therefore, the swing analyzing unit 211 can calculate the scale factor H by Equation (15).

$$H = \frac{2 \cdot ( {L}_{1} + {L}_{2} )}{{L}_{3}} \qquad ( 15 )$$

In addition, the swing analyzing unit 211 can calculate the length L₃ of the third line segment 53 by using the Y coordinate A_{Y} and the Z coordinate A₂ of the predetermined position 63 according to Equation (13).

Next, the swing analyzing unit 211 calculates coordinates (−UL/2, H_{Y}, H_{Z}) of the apex H1 of the Hogan's plane HP, coordinates (UL/2, H_{Y}, H_{Z}) of the apex H2, using the coordinates (0, H_{Y}, H_{Z}) of the midpoint H3 and the width of the Hogan's plane HP in the X-axis direction (the length of the first line segment 51). Since the two apexes U1 and U2 of the Hogan's plane HP are common to the shaft plane SP, the swing analyzing unit 211 does not need to calculate the coordinates of the apexes U1 and U2 of the Hogan's plane HP.

In this manner, the swing analyzing unit 211 can calculate the coordinates of the four apexes U1, U2, H1, and H2 of the Hogan's plane HP.

The region sandwiched between the shaft plane SP (the first virtual surface) and the Hogan's plane HP (the second virtual surface) is called “V zone”, and it is possible to estimate the trajectory (the course of the ball) of hitting the ball to some extent depending on the relationship between the position of the head 3a of the golf club 3 during backswing and downswing and the V zone. For example, in a case where the head 3a of the golf club 3 exists in a space lower than the V zone at a predetermined timing during the backswing or downswing, it is easy to become hook type hitting. In addition, in a case where the head 3a of the golf club 3 exists in a space higher than the V zone at a predetermined timing during the backswing or downswing, it is easy to become slide type hitting. In the present embodiment, as clear from FIG. 13, an angle 3 formed by the shaft plane SP and the Hogan's plane HP is determined according to the length L₁ of the shaft of the golf club 3 and the length L₂ of the arm of the user 2. That is, since the angle β is not a fixed value, and is determined depending on the type of the golf club 3 and the body of the user 2, more suitable shaft plane SP and Hogan's plane HP (the V zone) are calculated as indices for diagnosing the swing of the user 2.

### 1-3-4. Calculation of Head 3a Position During Halfway Back and Halfway Down

The position of the head 3a at the time of the halfway back is the position of the head 3a at the moment of halfway back, immediately before halfway back, or immediately after halfway back. The position of the head 3a at the halfway down is the position of the head 3a at the moment of halfway down, immediately before halfway down or immediately after halfway down.

First, the swing analyzing unit 211 calculates the position of the head 3a and the grip end position 62 at each time t using the position and posture of the sensor unit 10 at each time t from the time tₛₜₐᵣₜ of the swing start to the time t_{impact} of the impact.

In particular, at each time t, the swing analyzing unit 211 sets the position separated by a distance L_{SH} from the position of the sensor unit 10 in the positive direction of the y-axis specified by the posture of the sensor unit 10 as a position of the head 3a, and calculates the coordinates of the position of the head 3a. As described above, the distance L_{SH} is a distance between the sensor unit 10 and the head 3a. In addition, at each time t, the swing analyzing unit 211 sets the position separated by a distance L_{SG} from the position of the sensor unit 10 in the negative direction of the y-axis specified by the posture of the sensor unit 10 as the grip end position 62, and calculates the coordinates of the grip end position 62. As described above, the distance L_{SG} is a distance between the sensor unit 10 and the grip end position 62.

Next, the swing analyzing unit 211 detects the timing of halfway back and the timing of halfway down using the coordinates of the position of the head 3a and the coordinates of the grip end position 62.

In particular, the swing analyzing unit 211 calculates a difference ΔZ between the Z coordinate of the position of the head 3a and the Z coordinate of the grip end position 62 at each time t from the time tₛₜₐᵣₜ of the swing start to the time t_{impact} of the impact. The swing analyzing unit 211 detects the time t_{HWB} at which the sign of ΔZ reverses from the time tₛₜₐᵣₜ of the swing start to the time tₜₒₚ of the top as the timing of halfway back. The swing analyzing unit 211 detects the time t_{HWD} at which the sign of ΔZ reverses from the time tₜₒₚ of the stop to the time t_{impact} of the impact as the timing of halfway back. Then, the swing analyzing unit 211 sets the position of the head 3a at the time t_{HWB} as the position of the head 3a at the halfway back, and sets the position of the head 3a at the time t_{D} as the position of the head 3a at the halfway down.

### 1-3-5. Calculation of Head Speed

The head speed is the magnitude of the velocity of the head 3a at the time of impact (the moment of impact, immediately before the impact, or immediately after the impact). For example, the swing analyzing unit 211 calculates the velocity of the head 3a at the time of impact t_{impact} by the difference between the coordinates of the position of the head 3a at the impact time t_{impact} and the coordinates of the position of the head 3a at the immediately preceding time. Then, the swing analyzing unit 211 calculates the magnitude of the velocity of the head 3a as the head speed.

### 1-3-6. Calculation of Face Angle and Club Path (Incident Angle)

The face angle is an index based on the inclination of the head 3a of the golf club 3 in the impact, and the club path (the incident angle) is an index based on the trajectory of the head 3a of the golf club 3 in the impact.

FIG. 14 is a diagram for illustrating a face angle and a club path (an incident angle). FIG. 14 illustrates the golf club 3 (only the head 3a is illustrated) on the XY plane viewed from the positive side of the Z-axis in the XYZ coordinate system. In FIG. 14, reference numeral 74 denotes a face surface (a hitting surface) of the golf club 3, and reference numeral 75 denotes a hitting point. Reference numeral 70 denotes a target line indicating the target direction of hitting the ball and reference numeral 71 denotes a plane orthogonal to the target line 70. In addition, reference numeral 76 denotes a curve indicating the trajectory of the head 3a of the golf club 3, and reference numeral 72 denotes a tangential line at the hitting point 75 with respect to the curve 76.

Here, the face angle is an angle formed of the plane 71 and the face surface 74, in other words, an angle formed of a straight line 73 orthogonal to the face surface 74 and the target line 70. The club path (the incident angle) W is an angle formed of the tangential line 72 (the direction in which the head 3a in the XY plane passes the hitting point 75) and the target line 70.

For example, the swing analyzing unit 211 determines that the angle formed of the face surface 74 of the head 3a and the X axis direction is always constant (for example, orthogonal) and calculates the direction of the straight line perpendicular to the face surface 74 from the posture of the sensor unit 10 at the impact time t_{impact}. The swing analyzing unit 211 calculates the angle (the face angle) ϕ formed of the straight line 73 and the target line 70 with the direction of the straight line 73 assuming that a Z-axis component of the direction of the straight line is 0.

Further, for example, the swing analyzing unit 211 sets the direction (that is, the velocity of the head 3a on the XY plane) of the velocity where the Z-axis component of the velocity of the head 3a in the time t_{impact} of the impact as a direction of the tangential line 72 is 0, and calculates an angle (the club path (the incident angle)) ψ formed of the tangential line 72 and the target line 70.

Since the face angle ϕ represents the inclination of the face surface 74 with reference to the target line 70 where the direction is fixed irrespective of the incident direction of the head 3a to the hitting point 75, it is called an absolute face angle. With respect to this, since the angle η formed of the straight line 73 and the tangential line 72 represents the inclination of the face surface 74 with reference to the incident direction of the head 3a to the hitting point 75, it is called a relative face angle. The relative face angle η is an angle obtained by subtracting the club path (the incident angle) ψ from (absolute) face angle ϕ.

### 1-3-7. Calculation of Shaft Axis Rotation Angle at Top

The shaft axis rotation angle θₜₒₚ at the top is an angle (the relative rotation angle) at which the golf club 3 is rotated around the shaft axis from the reference timing to the top timing. The reference timing is, for example, at the time of backswing start or address. In the present embodiment, in a case where the user 2 is right-handed, a tightening direction of a right screw with its tip directed toward the head 3a side of the golf club 3 (the clockwise direction when viewing the head 3a side from the grip end side) is defined as a positive direction of shaft axis rotation angle θₜₒₚ. Conversely, in a case where the user 2 is left-handed, the tightening direction of the left screw with its tip directed toward the head 3a side of the golf club 3 (the counterclockwise direction when viewing the head 3a side from the grip end side) is defined as the positive direction of the shaft axis rotation angle θₜₒₚ.

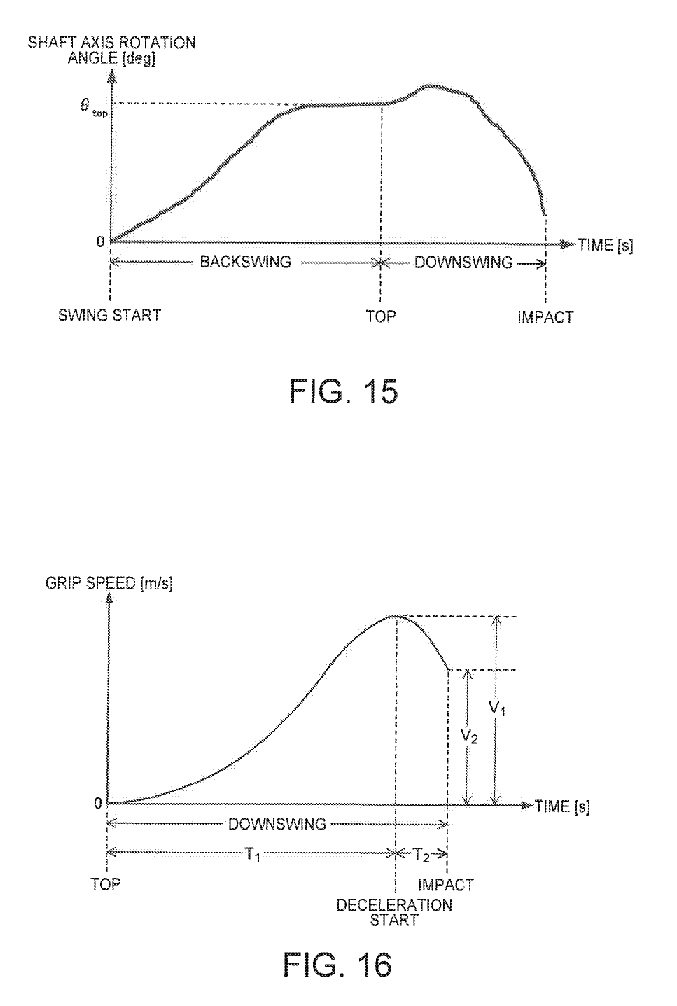

FIG. 15 is a diagram illustrating an example of a time variation of a shaft axis rotation angle from a swing start (a backswing start) to an impact. In FIG. 15, the horizontal axis represents the time (s) and the vertical axis represents the shaft axis rotation angle (deg). FIG. 15 illustrates the shaft axis rotation angle θₜₒₚ at the top when the swing is started (at the start of the backswing) at the reference timing (shaft axis rotation angle is 0°).

In the present embodiment, as illustrated in FIG. 3, the y-axis of the sensor unit 10 substantially coincides with the longitudinal direction of the shaft of the golf club 3 (the longitudinal direction of the golf club 3). Therefore, for example, the swing analyzing unit 211 time-integrates the y-axis angular velocity included in the angular velocity data from the time tₛₜₐᵣₜ of the swing start (at the start of the backswing) or the time tₜₒₚ (top time) from the address time to the top, and a shaft axis rotation angle θₜₒₚ is calculated.

### 1-3-8. Calculation of Grip Deceleration Rate and Grip Deceleration Time Rate

The grip deceleration rate is an index based on the deceleration amount of the grip and is the ratio of the velocity of the grip when the grip begins to decelerate during the downswing and the velocity of the grip at the impact. In addition, the grip deceleration time rate is an index based on the deceleration period of the grip, and is the ratio of the time from the start of deceleration of the grip to the impact to the time of the downswing during the downswing. The velocity of the grip is desirably the velocity of the part held by the user 2. However, the velocity may be the velocity of an arbitrary part (for example, the grip end) of the grip, or the velocity of the part in the vicinity of the grip.

FIG. 16 is a diagram illustrating an example of the time variation of the velocity of the grip in the downswing. In FIG. 16, the horizontal axis represents the time (s) and the vertical axis represents the velocity (m/s) of the grip. In FIG. 16, when the grip velocity (the maximum grip velocity) when the grip starts to decelerate is defined as V₁ and the impact grip velocity at the impact is defined as V₂, when the grip deceleration rate R_{V} (unit: %) is expressed by Equation (16) below.

$${R}_{V} = \frac{{V}_{1} - {V}_{2}}{{V}_{1}} \times 100 ( \% ) \qquad ( 16 )$$

In addition, in FIG. 16, when the time from the top to the start of the deceleration of the grip is defined T₁ and the time from the start of the deceleration of the grip to the impact is defined as T₂, the grip deceleration time rate R_{T}(unit: %) is expressed by Equation (17) below.

$${R}_{T} = \frac{{T}_{2}}{{T}_{1} + {T}_{2}} \times 100 ( \% ) \qquad ( 17 )$$

For example, the velocity of the sensor unit 10 may be regarded as the velocity of grip on the assumption that the sensor unit 10 is attached near the portion where the user 2 grips the golf club 3. Therefore, firstly, the swing analyzing unit 211 calculates the velocity of the sensor unit 10 at each time t by the difference between the coordinates of the position of the sensor unit 10 at each time t from the top time tₜₒₚ to the impact time t_{impact} (during downswing) and the coordinates of the position of the sensor unit 10 at the immediately preceding time.

Next, the swing analyzing unit 211 calculates the magnitude of the velocity of the sensor unit 10 at each time t, and sets the maximum value thereof as V₁ and the magnitude of the velocity as the impact time t_{impact} as V₂. In addition, the swing analyzing unit 211 specifies the time tᵥₘₐₓ at which the velocity of the sensor unit 10 reaches the maximum value V₁. Further, the swing analyzing unit 211 calculates T1=tᵥₘₐₓ−tₜₒₚ and T2=t_{impact}−tᵥₘₐₓ. The swing analyzing unit 211 calculates the grip deceleration rate R_{V} and the grip deceleration time rate R_{T} by Equations (16) and (17), respectively.

The swing analyzing unit 211 regards the grip end velocity as the grip speed, calculates the velocity of the grip end based on the coordinates of the position of the grip end at each time t in the downswing, and may calculate the grip deceleration rate R_{V} and the grip deceleration time rate R_{T} by the same calculation as described above.

### 1-3-9. Calculation of Attack Angle and Definition of Sign of Attack Angle and Face Angle

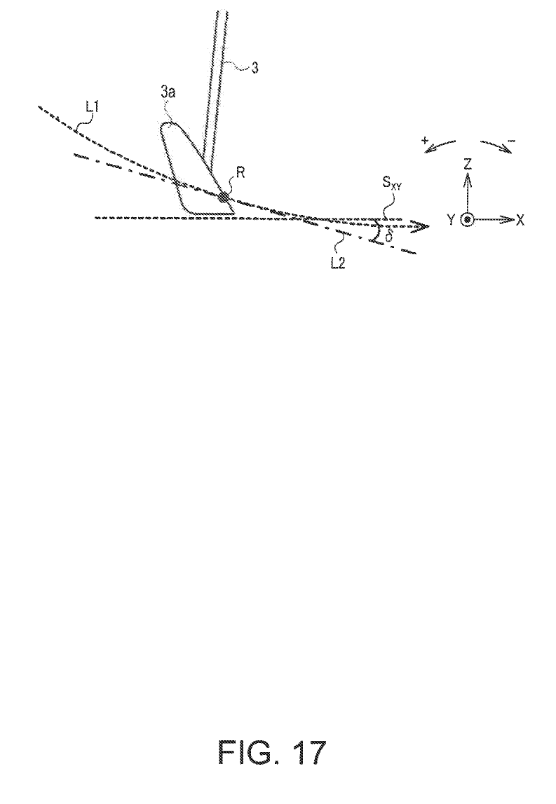

FIG. 17 is a diagram for explaining the definition of the attack angle (the first angle) δ. In the present embodiment, the XYZ coordinate system in which the target line indicating the hitting target direction is the X-axis, the axis on the horizontal plane perpendicular to the X-axis is the Y-axis, and the Z-axis is the upward vertical direction (the direction opposite to the direction of the gravitational acceleration), and the X-axis, the Y-axis, and the Z axis are illustrated in FIG. 17. The target line is, for example, a target direction in which the user hits the ball straightly. In FIG. 17, a point R is a shot point where the head 3a of the golf club 3 hits the golf ball 4, a curve L1 is a part of a trajectory of the head 3a of the golf club 3 in the XZ plane at the time of swing, and a straight line L2 is a tangent to the curve L1 at the shot point R on the XZ plane. As illustrated in FIG. 17, the attack angle is defined as the angle δ of the straight line L2 with respect to the XY plane (the horizontal plane) S_{XY}. In addition, in FIG. 17, the rightward direction toward a paper surface along the X-axis parallel to the XY plane (horizontal plane) S_{XY} is the shot target direction. Therefore, the attack angle δ can be set as the direction of the tangential line (the straight line L2) in contact with the swing trajectory (the curve L1) of the head (shot portion) 3a of the golf club (motion equipment) 3, the direction of the batting target direction along the X-axis.

The shot target direction includes a direction orthogonal to the face surface of the head 3a of the golf club 3, a shot direction set by the user 2 in advance, a direction connecting straight distances to a cup, and the like.

In the present embodiment, regarding the sign of the attack angle (the first angle) δ, the direction in which +Z (vertically upward) of the Z-axis rotates in the +X direction (right direction toward the paper surface) of the X-axis (the clockwise direction in the same drawing) using the Y-axis as the rotation axis is defined as a first sign and the opposite sign to the first sign is defined as a second sign. As illustrated in FIG. 17, for example, the first sign is negative (−) and the second sign is positive (+). The sign of the attack angle (the first angle) δ illustrated in FIG. 17 is the first sign (negative). That is, the attack angle is satisfied by δ<0°, at the time of down-blowing when the head 3a is inclined diagonally downward and downward toward the paper surface with respect to the shot point R. The attack angle is satisfied by δ=0°, at the time when the head 3a is level blowing horizontally along the X axis with respect to the shot point R. The attack angle is satisfied by δ>0° at the time of upper blowing in which the head 3a obliquely enters in the upper right direction toward the paper surface with respect to the shot point R.

In the present embodiment, regarding the sign of the face angle (the second angle) ϕ illustrated in FIG. 14, the direction in which +Y of the Y-axis rotates, about the Z-axis as the rotation axis, in the +X direction of the X-axis (the clockwise direction toward the paper surface in the same drawing) using the Y-axis as the rotation axis is defined as a third sign and the opposite sign to the third sign is defined as a fourth sign. As illustrated in FIG. 14, for example, the third sign is negative (−) and the fourth sign is positive (+). The sign of the face angle (the second angle) ϕ illustrated in FIG. 14 is the third sign (negative). That is, the face angle is satisfied by ϕ<0°, at the time of down-blowing when the head 3a is closed in the inside-out and leads to the impact. The face angle is satisfied by ϕ=0°, at the time when the face surface 74 of the head 3a is square in which it is perpendicularly incident on the target line. The face angle is satisfied by ϕ>0° at the time the head 3a reaches the impact in the open state at the outside-in.

The swing analyzing unit 211 illustrated in FIG. 6 can include a first angle calculation unit that calculates the attack angle (the first angle) δ and a second angle calculation unit that calculates the face angle (the second angle) ϕ. The first and second angle calculation units calculate the first and second angles δ and ϕ from the relationship illustrated in FIGS. 17 and 14 using the output from the data acquisition unit 210 illustrated in FIG. 6, that is, the output of the sensor unit 10.

### 1-3-10. Procedure of Swing Analyzing Process (Swing Analyzing Method)

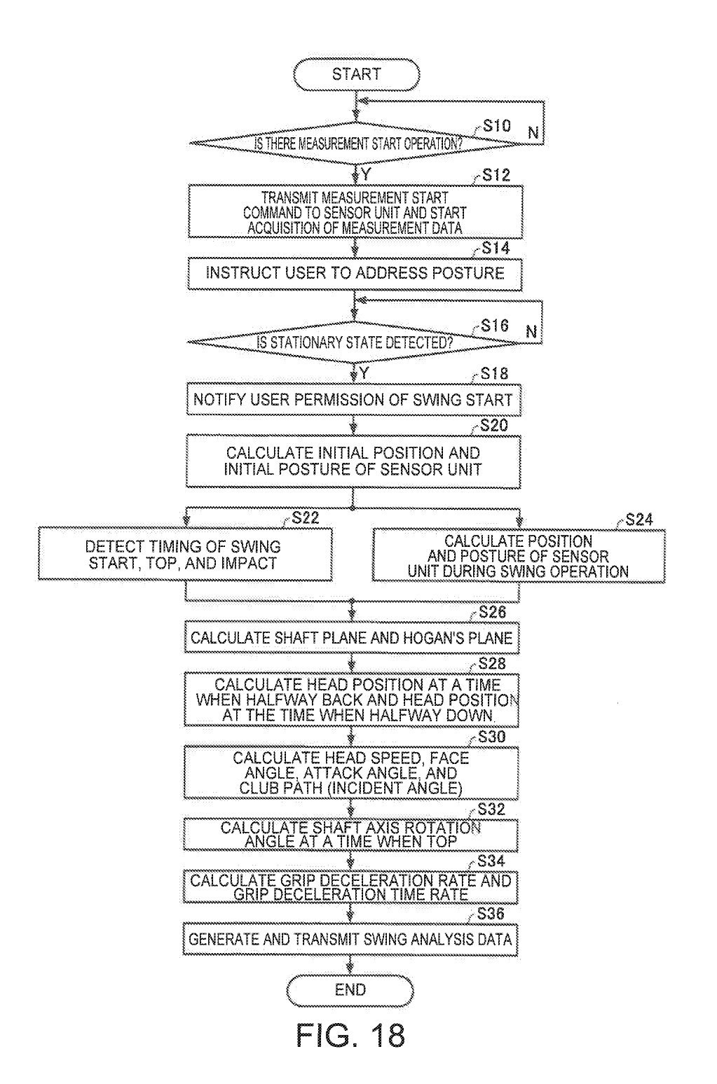

FIG. 18 is a flowchart illustrating an example of a procedure of the swing analysis process (a swing analyzing method) by the processing unit 21. By executing the swing analyzing program 240 stored in the storage unit 24, the processing unit 21 executes the swing analyzing process, for example, in the procedure of the flowchart of FIG. 18. Hereinafter, the flowchart of FIG. 18 will be described.

First, the processing unit 21 stands by until the measurement start operation (the operation in step S2 of FIG. 4) is performed by the user 2 (N in S10), and when the measurement start operation is performed (Y in S10), the measurement start command is transmitted to the sensor unit 10 and the acquisition of the measurement data is started from the sensor unit 10 (S12).

Next, the processing unit 21 instructs the user 2 to take the address posture (S14). According to the instruction, the user 2 takes the address posture and stands still for a predetermined time or longer (step S4 of FIG. 4).

Next, when the processing unit 21 detects the stationary state of the user 2 using the measurement data acquired from the sensor unit 10 (Y in S16), the processing unit 21 notifies the user 2 of the permission of the swing start (S18). For example, the processing unit 21 notifies the user 2 the permission of the swing start by, for example, outputting a predetermined sound or by providing an LED in the sensor unit 10 and turning on the LED or the like, and after confirming this notification, the swing operation (the operation of step S6 in FIG. 4) is started.

Next, the processing unit 21 performs the process of step S20 and the subsequent steps after the swing motion of the user 2 is completed or before the swing operation is ended.

First, the processing unit 21 calculates the initial position and the initial posture of the sensor unit 10 using measurement data (measurement data at the time of stationary (at the time of addressing) of the user 2) acquired from the sensor unit 10 (S20).

Next, the processing unit 21 detects the timings of the address start, the swing start, the top, and the impact using the measurement data acquired from the sensor unit 10 (S22). At the same time, the processing unit 21 calculates the swing pace based on the detected timings of address start, the swing start, the top, and the impact.

In addition, the processing unit 21 calculates the position and the posture of the sensor unit 10 during the swing operation of the user 2 in parallel with or before or after the process in step S22 (S24).

Next, in steps S26 to S34, the processing unit 21 calculates the values of various types of indices relating to the above-described swing using at least a part of the measurement data acquired from the sensor unit 10, each timing of the swing start, the top, and the impact which are detected in step S22, and the position and the posture of the sensor unit 10 calculated in Step S24.

In step S26, the processing unit 21 calculates the shaft plane SP and the Hogan's plane HP.

In addition, in step s28, the processing unit 21 calculates the head 3a position at the time of halfway back and the head 3a position at the time of halfway down.

In addition, in step S30, the processing unit 21 calculates the head speed, the face angle ϕ, and attack angle δ, and the club path (the incident angle) ψ.

In addition, in step S32, the processing unit 21 calculates the shaft axis rotation angle θₜₒₚ at the time when top.

In addition, in step S34, the processing unit 21 calculates the grip deceleration rate R_{V} and the grip deceleration time rate R_{T}.

The processing unit 21 generates the swing analysis data 248 using various types of indices calculated in Step S26 to S34, transmits the data to the swing diagnostic device 30 (S36), and ends the swing analyzing process.

In the flowchart of FIG. 18, the order of each steps may be appropriately changed, or some of the steps may be deleted or changed, or the other steps may be added.

### 1-4. Configuration of Swing Diagnostic Device

In the present embodiment, a configuration for performing a swing diagnosis using the swing diagnostic device 30 as the computation unit will be exemplified and described. In this swing diagnosis, the above-described swing analyzing apparatus 20 is provided with the computation unit having the same function as that of the swing diagnostic device 30, and the swing diagnosis can be performed by the swing analyzing apparatus 20.

FIG. 19 is a diagram illustrating a configuration example of the swing diagnostic device 30. As illustrated in FIG. 19, in the present embodiment, the swing diagnostic device 30 as the computation unit is configured by including the processing unit 31, the communication unit 32, and a storage unit 34. However, the swing diagnostic device 30 may have a configuration in which some of these constituent elements are deleted or changed, or other constituent elements are added as appropriate.

The storage unit 34 is configured by various IC memories such as a read only memory (ROM), a flash ROM, or a random access memory (RAM), or a recording medium such as a hard disk or a memory card. The storage unit 34 stores programs for the processing unit 31 to perform various calculation processes and control processes, various programs and data for realizing application functions, and the like.

In the present embodiment, the storage unit 34 stores a swing diagnosis program 340 read by the processing unit 31 and for executing a swing analysis process. The swing diagnosis program 340 may be stored in advance in a nonvolatile recording medium (a computer readable recording medium), or may be stored in a server (not illustrated) by the processing unit 31 via the network 40 or in the storage unit 34 by receiving the swing diagnosis program 340 from the swing diagnostic device 30.

In addition, in the present embodiment, a swing analysis data list 341 including the plurality of swing analysis data items 248 generated by the swing analyzing apparatus 20 is stored (saved) in the storage unit 34. That is, the swing analysis data items 248 which are generated each time when the processing unit 21 of the swing analyzing apparatus 20 analyzes the swing operation of the user 2 are sequentially added to the swing analysis data list 341.

Furthermore, in the present embodiment, a V zone score table 342, a rotation score table 343, an impact score table 344, an speed score table 345, a pace score table 346, and a swing efficiency score table 347 are stored in the storage unit 34.

In addition, the storage unit 34 is used as a work area of the processing unit 31, and temporarily stores operation results executed by the processing unit 31 according to various programs, and the like. Furthermore, the storage unit 34 may store data requiring long-term storage, among the data items generated by the processing of the processing unit 31.

The communication unit 32 performs data communication with the communication unit 27 (see FIG. 6) of the swing analyzing apparatus 20 via the network 40. For example, the communication unit 32 receives the swing analysis data 248 from the communication unit 27 of the swing analyzing apparatus 20 and performs a process of transmitting the data to the processing unit 31. In addition, for example, the communication unit 32 performs a process of transmitting the information required for displaying the selection screen to the communication unit 27 of the swing analyzing apparatus 20 or a process of receiving the information selected in the selection screen from the processing unit 21 and transmitting the information to the processing unit 31 from the communication unit 27 of the swing analyzing apparatus 20. In addition, for example, the communication unit 32 performs a process of receiving the information required for displaying the input data editing screen from the processing unit 31 and transmitting the information to the communication unit 27 of the swing analyzing apparatus 20. In addition, for example, the communication unit 32 performs a process of receiving input data when a diagnosis start button in the input data editing screen is pressed from the communication unit 27 of the swing analyzing apparatus 20 and transmitting the data to the processing unit 31, and receiving the information of the diagnostic result based on the input data (the scores or a total point of a plurality of items indicating the characteristics of the swing of the user 2) based on the input data from the processing unit 31 and transmitting the information to the communication unit 27 of the swing analyzing apparatus 20. In addition, for example, the communication unit 32 performs a process of receiving the information required for displaying the swing diagnosis screen from the processing unit 31 and transmitting the information to the communication unit 27 of the swing analyzing apparatus 20.

The processing unit 31 performs a process of receiving the swing analysis data 248 from the swing analyzing apparatus 20 via the communication unit 32 according to various types of programs and causing the storage unit 34 to store the data (adding to the swing analysis data list 341). In addition, the processing unit 31 performs a process of receiving various types of information items from the swing analyzing apparatus 20 via the communication unit 32 according to various types of programs and transmitting the information required for display of various types of screens to the swing analyzing apparatus 20. In addition, the processing unit 31 performs the other various types of control processes.

In particular, in the present embodiment, the processing unit 31 functions as a data acquisition unit 310, a score calculation unit 311, and a storage processing unit 312 by executing the swing diagnosis program 340, and performs a diagnosis process (a swing diagnosis process) on the analysis data 248 which is selected from the swing analysis data list 341.

The data acquisition unit 310 performs a process of receiving the swing analysis data 248 received from the swing analyzing apparatus 20 in the communication unit 32 and transmitting the data to the storage processing unit 312. In addition, the data acquisition unit 310 performs a process of receiving various types of information items received from the swing analyzing apparatus 20 in the communication unit 32 and transmitting the information to the score calculation unit 311.

The storage processing unit 312 performs a read and write process of various types of program or various types of data items with respect to the storage unit 34. For example, the storage processing unit 312 performs a process of receiving the swing analysis data 248 from the data acquisition unit 310 and storing the data to the storage unit 34 (adding to the swing analysis data list 341) or a process of reading the swing analysis data 248 from the swing analysis data list 341 stored in the storage unit 34. In addition, for example, the storage processing unit 312 performs a process of reading the V zone score table 342, the rotation score table 343, the impact score table 344, the speed score table 345, the pace score table 346, and the swing efficiency score table 347 which are stored in the storage unit 34.

The score calculation unit 311 (a level calculation unit) performs a process of calculating the score (level) of a plurality of items based on the data on the swing. In the present embodiment, the data on the swing may be input data when a diagnosis start button is pressed on the input data editing screen, or may be the swing analysis data 248 selected on the selection screen, and may include both of data items.

For example, in the input data editing screen, on a case where the diagnosis start button is pressed without editing each index such as the gender, the type of the golf club and the swing, the score calculation unit 311 performs a process of calculating the score based on the swing analysis data 248 selected from the swing analysis data list 341. On the other hand, on the input data editing screen, in a case where the diagnosis start button is pressed after editing at least one of indices of the gender, the type of the golf club and the swing, the score calculation unit 311 performs a process of calculating the score based on the data (pseudo data) which is obtained that at least a part of the selected swing analysis data 248 is edited.

In addition, the score calculation unit 311 performs a process of calculating the total point based on the scores of plurality of items. The processing unit 31 transmits the information of the scores of the plurality of items or the total point which is calculated by the score calculation unit 311 to the swing analyzing apparatus 20 via the communication unit 32. That is, the processing unit 31 functions as the output unit that outputs the information of the scores (level) of the plurality of items and the total point.

### 1-5. Swing Diagnosis Processing

In the present embodiment, the processing unit 31 of the swing diagnostic device 30 performs a process of calculating the scores of a plurality of items and the total points indicating characteristics of the swing as a swing diagnosis process.

### 1-5-1. Calculation of Score of “V Zone” Item

The score calculation unit 311 calculates the score of the “V zone” item depending on the head 3a position at the time when the halfway back and the halfway down belongs to which range among the plurality of ranges determined based on the shaft plane SP and the Hogan's plane HP (V zone), respectively. Next, the score calculation unit 311 calculates the score (1 to 5 points) corresponding to the determination result with reference to the preset V zone score table 342.

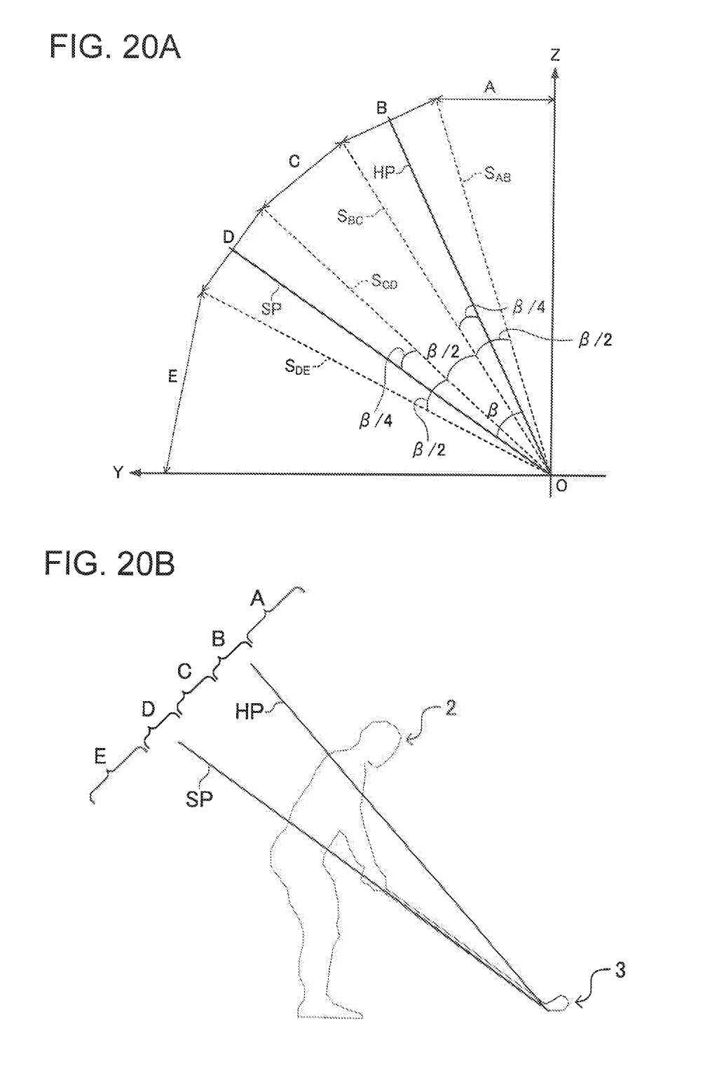

FIGS. 20A and 20B are diagrams illustrating an example of a relationship between the shaft plane and the Hogan's plane (the V zone), and a plurality of regions. FIG. 20A illustrates the relationship between the shaft plane SP, the Hogan's plane HP, and the five regions A to E in a case viewed from the negative side of the X-axis (projected on the YZ plane). FIG. 20B is a diagram illustrating an example of an outline of the shaft plane SP and the Hogan's plane HP, and the posture of the user 2. A region B is a predetermined space including the Hogan's plane HP, and a region D is a predetermined space including the shaft plane SP. A region C is a space sandwiched between the area B and the region D (a space between a boundary surface S_{BC} of the region B and a boundary surface S_{CD} of the region D). The region A is a space which is in contact with the region B at a boundary surface SA on the region C side. The region E is a space which is in contact with the region D at a boundary surface S_{DE} on the region C side.

The score calculation unit 311 may calculate the score as much as the hitting ball predicted on the basis of the relationship between the shaft plane SP, the Hogan's plane HP, the position of the head 3a at the time when the halfway back, and the position of the head 3a at the time when the halfway down. “Tends to be curved” means that the trajectory after hitting the ball tends to be curved (it tends to be a slice or a hook), or the direction of hitting the ball may deviate from the target direction (the target line). Alternatively, the score calculation unit 311 may calculate a higher score as hitting the ball easy to fly straight. “Easy to fly straight” means that the trajectory after hitting is difficult to be curved (easy to be straight), or the direction of the hitting ball is difficult to deviate from the target direction (target line).

For example, in a case where the position of the head 3a at the halfway back belongs to the area E and the position of the head 3a at the halfway down belongs to the area A, since it is predicted that the hitting the ball becomes easy, the score calculation unit 311 calculates a relatively low score.

### 1-5-2. Calculation of Score of “Rotation” Item

The score calculation unit 311 calculates the score of the “rotation” item according to which region of the plurality of regions of the face angle ϕ and the shaft axis rotation angle θₜₒₚ at the top belongs. In particular, first, the score calculation unit 311 determines whether the shaft axis rotation angle θₜₒₚ at the top and the face angle ϕ included in the data relating to the swing (input data of the diagnosis object) belongs to which region. Next, the score calculation unit 311 calculates the score (1 to 5 points) corresponding to the determination result with reference to the preset rotation score table 343.

### 1-5-3. Calculation of Score of “Impact” Item

The score calculation unit 311 calculates the score of the “impact” item according to which of the plurality of regions each of the club path (the incident angle) ψ and the relative face angle η belongs. In particular, first, the score calculation unit 311 determines whether the club path (the incident angle) ψ included in the data relating to the swing (input data of the diagnosis object) belongs to which region. In addition, the score calculation unit 311 calculates the relative face angle η (see FIG. 14) by subtracting the club path (the incident angle) ψ from the face angle ϕ included in the data on the swing (input data of the diagnosis object) (see FIG. 14) to which region the face angle η belongs to which region. Next, the score calculation unit 311 calculates the score (1 to 5 points) corresponding to the determination result with reference to the preset impact score table 344.

### 1-5-4. Calculation of Score of “Speed” Item

The score calculation unit 311 calculates the score of the “speed” item according to which of the plurality of regions the operation speed of the golf club 3 belongs. In particular, first, the score calculation unit 311 calculates the score of the “speed” item according to which of the plurality of regions the operation speed at the time of impact belongs. Next, the score calculation unit 311 calculates the score (1 to 5 points) corresponding to the determination result with reference to the preset speed score table 345.

### 1-5-5. Calculation of Score of “Pace” Item

The score calculation unit 311 calculates the score of the “pace” item according to which region of the plurality of regions the swing pace calculated based on the timing of the address start, the swing start, the top, and the impact belongs. In particular, first, the score calculation unit 311 calculates the score of the “pace” item depending on which of the plurality of regions belongs to the calculated pace of the swing. Next, the score calculation unit 311 refers to the preset pace score table 346 and calculates the score (1 to 5 points) corresponding to the determination result.

### 1-5-6. Calculation of Total Point

The score calculation unit 311 calculates the total point based on the score of the “V zone” item, the score of the “rotation” item, the score of the “impact” item, the score of the “speed” item, and the score of the “pace” item. For example, in a case where the score of each item is a full score of 5 points, the full score of the total score is set to 25 points.

In the present embodiment, the method of calculating the score of each item relating to the swing performed by the score calculation unit 311 and the method of calculating the total point are explained using the score calculation unit 311 of the processing unit 31 included in the swing diagnostic device 30 as the computation unit. However, it is not limited thereto. For example, using the swing analyzing unit 211 of the processing unit 21 included in the swing analyzing apparatus 20 as the computation unit, it is possible to calculate the score of each item relating to the swing and calculate the total point by the swing analyzing unit 211.

### 1-6. Swing Analyzing Method

Based on each score (the evaluation result) calculated and quantified as described above, the processing unit 21 detects that the value deviates from the predetermined range by the swing analyzing unit 211, and the play state including the strong and weak golf swings of the user 2 is obtained from the detection result in the plurality of swings. Then, the processing unit 21 can output from the image data generation unit 212 as image data corresponding to the image (for example, see FIG. 29 to FIG. 34) representing the obtained play state of the user 2. In this manner, since the play state including the strong point and weak point in the golf swing of the user 2 is output, the user 2 can know the weak point in his or her own golf swing. The user can exercise the play after knowing the weak point of the play, and can perform efficient exercise corresponding to the weak point. In addition, since the motion state is quantified by the plurality of indices, it is possible to more precisely perform the output in the play state.

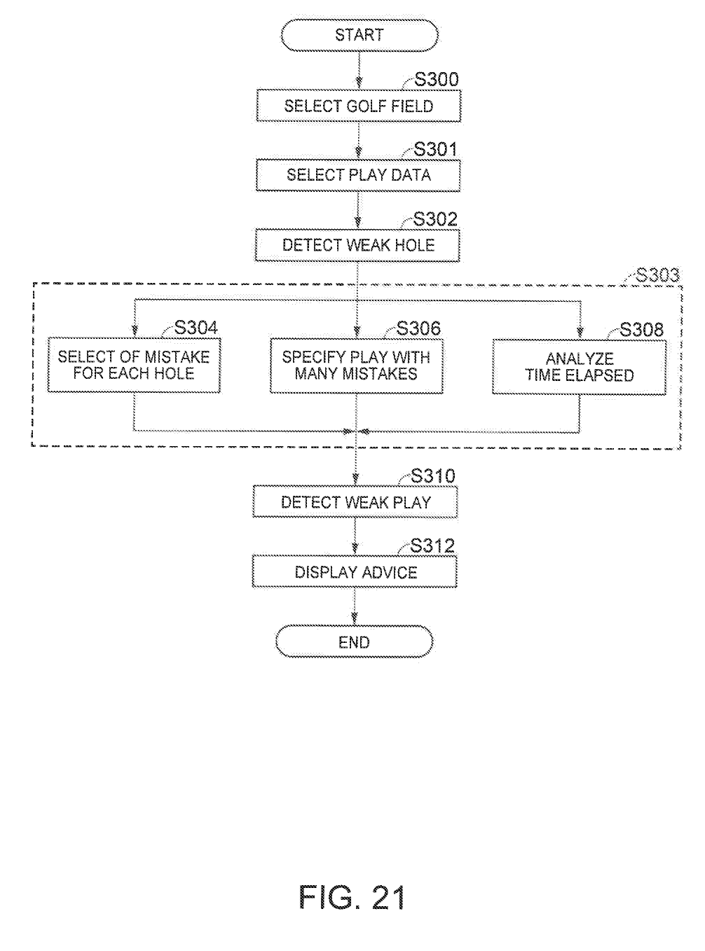

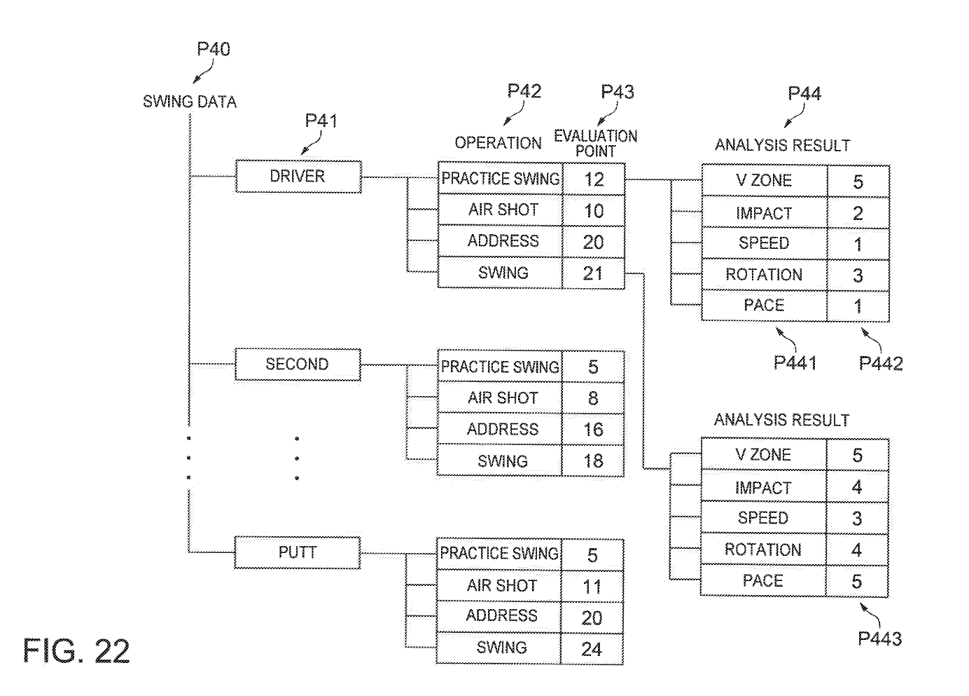

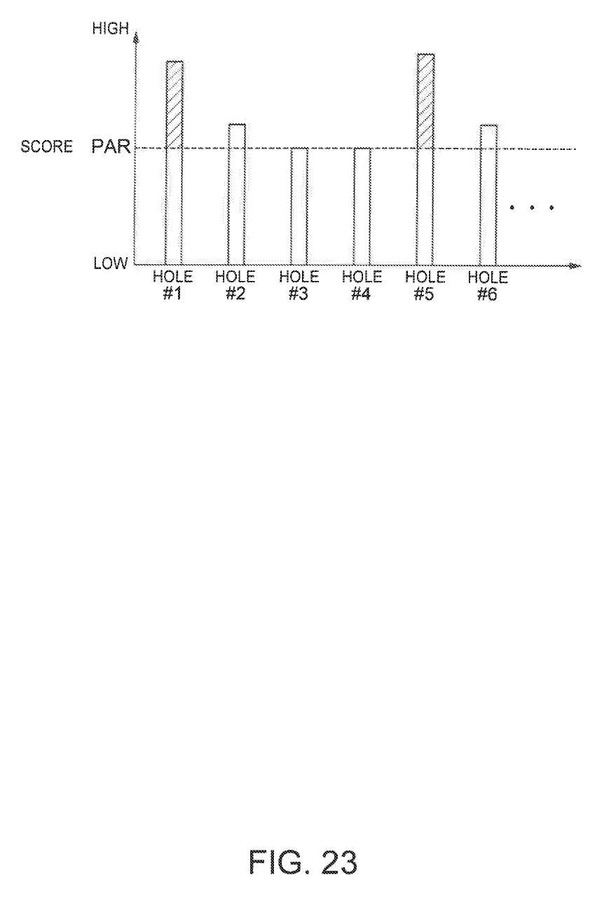

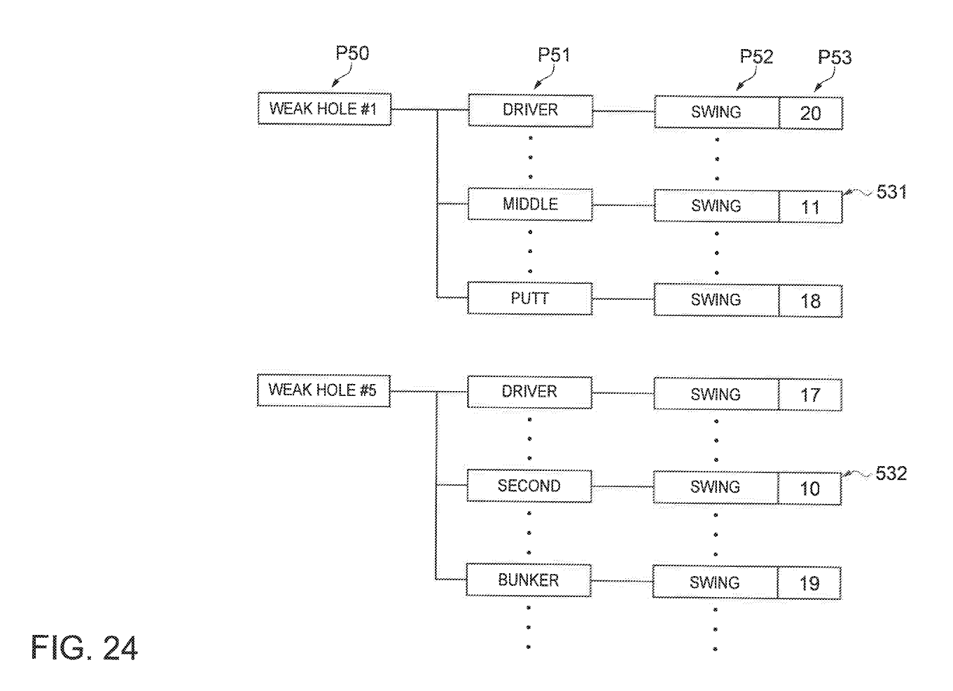

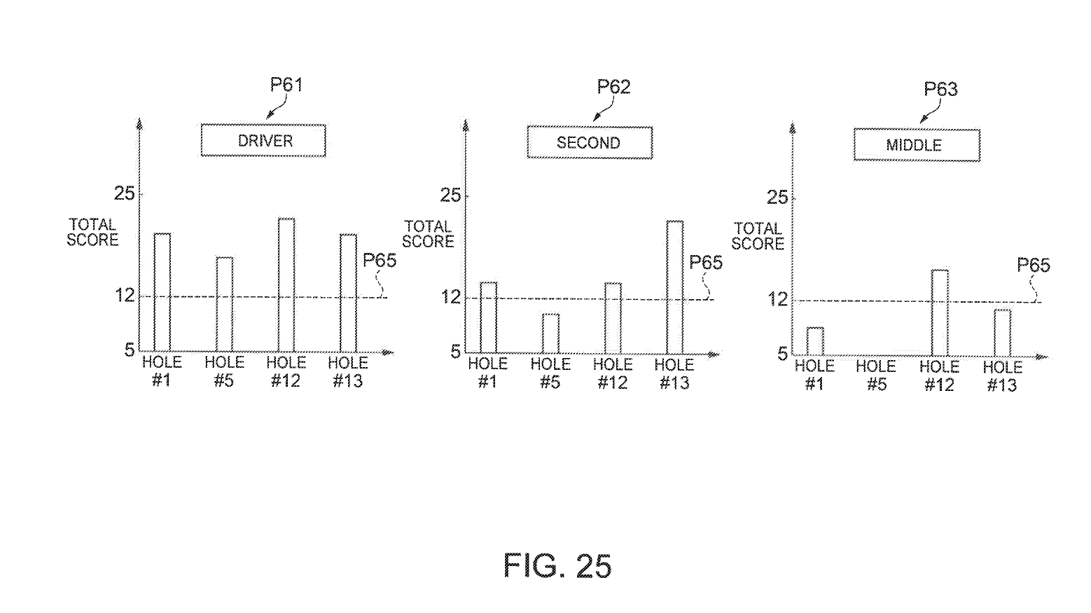

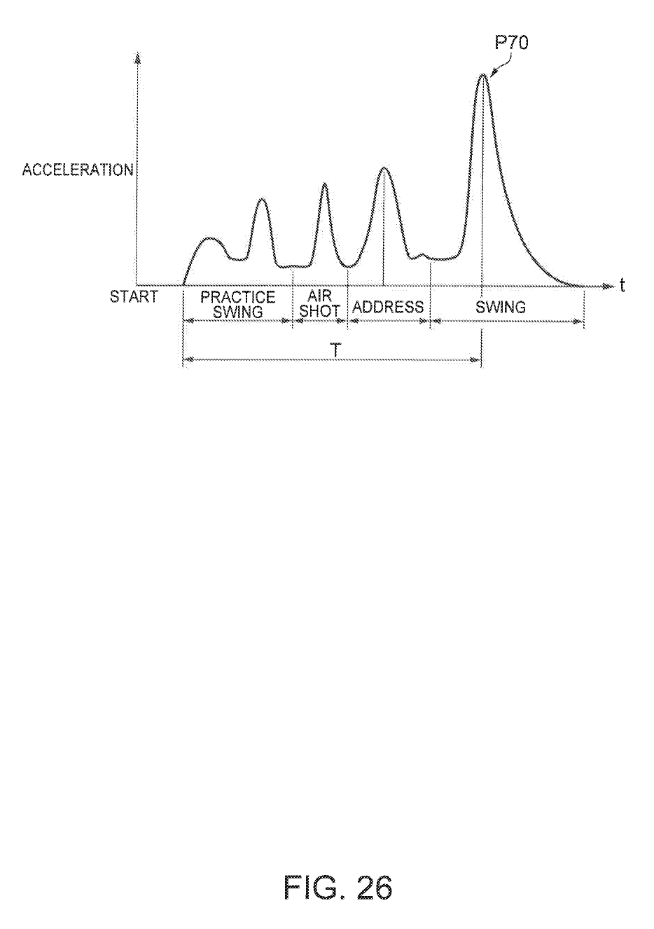

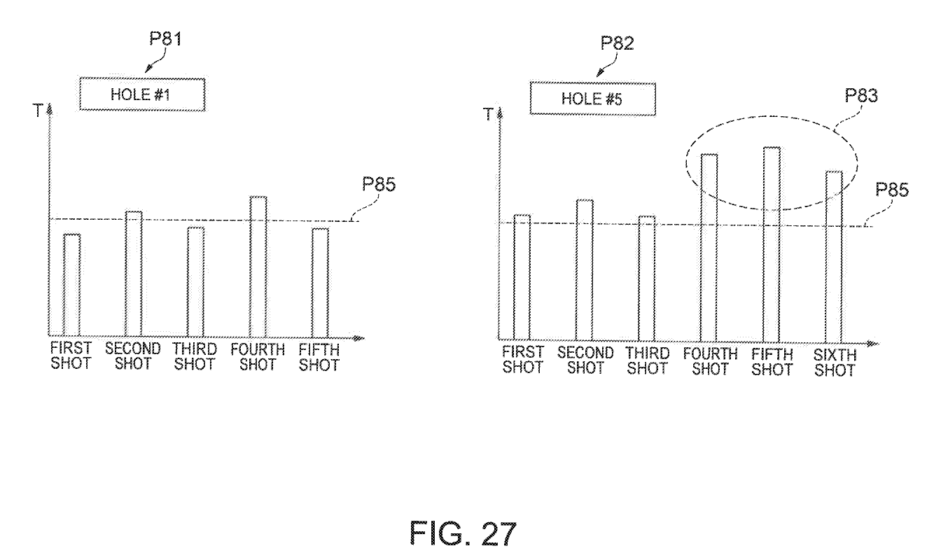

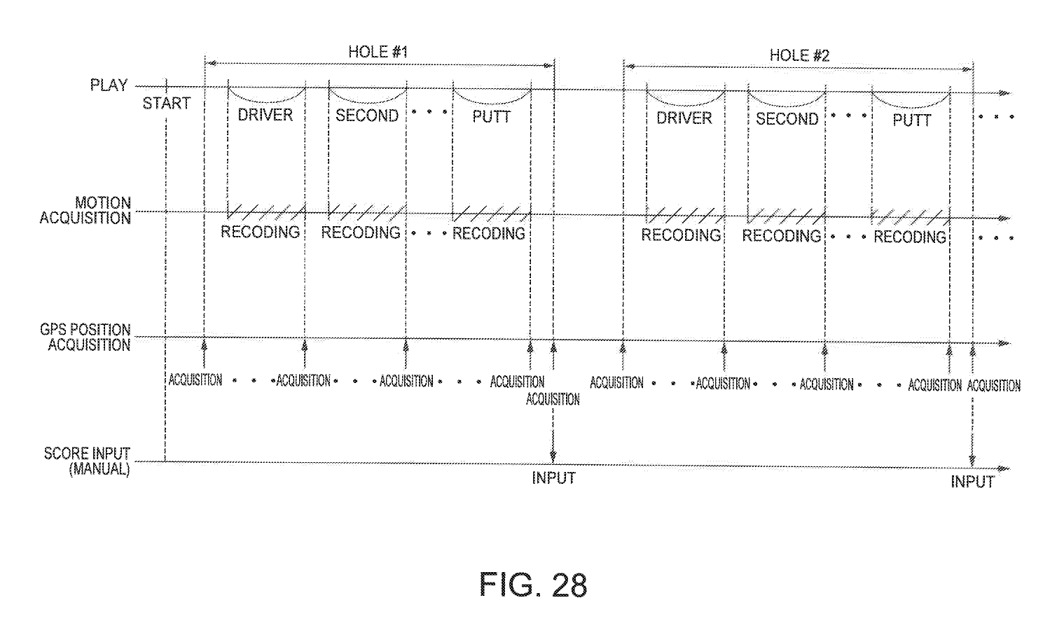

A method for obtaining the play state including the strong point and the weak point in the golf swing of the user 2 from the detection result in the plurality of swings based on each quantified score (the evaluation result) will be described in detail with respect to FIG. 21 to FIG. 28. FIG. 21 is a flowchart illustrating an example of a procedure of a motion analyzing method according to the present embodiment. FIG. 22 is a diagram illustrating an example of quantifying (scoring) the state of the swing. FIG. 23 is a diagram illustrating an example of a method for specifying a weak hole. FIG. 24 is a diagram illustrating an example of an analysis result of the swing relating to the weak hole. FIG. 25 is a diagram illustrating a comparison of scores for hit balls (shots) of the weak hole. FIG. 26 is a diagram illustrating a typical example of a change in acceleration from the start to the end of the shot. FIG. 27 is a diagram illustrating an example of elapsed time for hit balls (shots) relating to weak holes #1 and #5. FIG. 28 is a time chart illustrating an example of a time procedure of recording of the motion analyzing method.

The swing analyzing method according to the present embodiment is realized by dividing the time into when playing and when exercising after play. In particular, in a certain golf field, it is assumed that there are a plurality of holes (courses) such as a hole #1, a hole #2, . . . , and a hole #n, the state of play performed in each hole is stored and analyzed as play data and the strong point and the weak point are shown. And at, by exercising the play based on the weak point indicated by the analysis during exercising, it is possible to overcome the weak point and improve the play. By repeating this circulation (cycle), it is possible to aim the further progress of play. Hereinafter, the swing analyzing method according to the present embodiment will be described with reference to the flowchart of FIG. 21.

First, the user 2 selects a golf field to play (step S300), and acquires course information on the golf field. Next, the user 2 performs the play and acquires play data (step S301). The acquired play data here is recorded as data of each hole in each hole (course) and in the order of play time. The data of each hole includes the data of the play, the information of the hole itself, the topography (including the shape, the bunker, the presence or absence of the pond, the position of the forest, the distance, inclination, and the like), and the attribute of the hole (for example, a number of hits (Par) which is defined in the hole). In addition, in the play data, information on user 2 (player) when playing in the hole is recorded. For example, the score of the hole, the swing data which is operation information when swinging, the type of club used, the history of position (time displacement of coordinates), the comment at that time (for example, memo such as “Condition was not good”, “Out of Bounds (OB)”) are recorded.

As information to be stored, an example of the state of swing quantified (scored), for example, will be described with reference to FIG. 22. FIG. 22 illustrates a detailed example of the quantified swing data. As illustrated in FIG. 22, the swing data P40 quantifies (indicated by the evaluation point P43) an operation P42 of a shot order P41 (for example, tee shots (drivers), second shots, . . . , Putts (putters), preliminary swings (practice swing or air shot) for each shot order P41) corresponding to each hole, the address, and the swing, respectively. The evaluation points P43 which are numerical values are calculated based on the swing analysis results P44 (for example, points P442 and P443 for each item (indicated by an index P441) such as the V zone and the impact relating to the operation of the practice swing or the swing). From these evaluation points P43, the quality of each swing is analyzed. For example, by indices of the V zone, the impact, the speed, the rotation, the pace (the swing pace), or the like relating to the swing, the comprehensive quality of the trajectory of the swing, the mobility, and time variation are quantified. At this time, it is possible to evaluate the swing with each index, for example, 5 points full (1 to 5 points) and the total evaluation point being 5 to 25 points (5 points×5 indices=25 points). It is possible to detect that the total evaluation point deviates from the predetermined range and to output the play state based on the detection results in the plurality of swings. In the example illustrated in FIG. 22, as indicated by the evaluation point P43, it is shown that the score of the practice swing is low, the score of the swing is high, and there is a weak point in the practice swing.

Next, the user 2 inputs the number of hits (scores) of each hole and compares the number of hits (score) in each hole with the prescribed number of hits (Par)) in each hole based on the input result. Then, the weak hole of the user 2 is specified based on the comparison result (step S302). In particular, as illustrated by hatching in FIG. 23, a hole in which the hole where the large number of hits (scores) for each hole are prominently larger than the prescribed number of hits (Par) of each hole is detected (extracted) as a weak hole of the user 2. In the example illustrated in FIG. 23, the hole #1 and the hole #5 are detected as weak holes. In step S302, the play state can be output based on the input result of the number of hits (scores) in each hole and the detection results in the plurality of swings described above. In this way, the numerical value which deviates from the predetermined range is detected from the result where the golf swing is quantified and the plurality of swings and the number of hits in the hole is quantified, and the play state can be output.

Next, the play in the weak hole based on the detection result (the hole #1 and the hole #5) is analyzed and it is analyzed where the weak point of the user 2 exists (step S303). In the analysis at step S303, for example, swing data of the hole #1 and the hole #5 detected as difficult holes are analyzed to select the mistake for each hole (step S304), select the play with many mistakes (step S306), and performs analysis of the elapsed time (step S308).

In the step S304 for selecting a mistake for each hole, as illustrated in FIG. 24, an evaluation point (score) P53 of this swing P52 in each shot P51 of the weak hole P50 (hole #1 and hole #5) and it is determined that there were a mistake in the shot with low evaluation point (score) P53. In the example illustrated in FIG. 24, at the evaluation points (scores) P53 on a scale of one to twenty-five, the evaluation point (score) 531 of the middle (the middle shot) of the hole #1 is 11 points and the evaluation point (score) 532 of the second (the second shot) of the hole #5 is 10 points. It is a low point if the evaluation score is less than half of the full score of 25 points. Therefore, it can be determined that these two shots are miss shots.

In addition, in step S306 of specifying play with many mistakes, as illustrated in FIG. 25, the evaluation points (total scores) in the weak hole for each shot are compared, the hole is determined that there are many mistakes, that is, there is a weak point in shots with low evaluation scores (total scores). In FIG. 25, the hole #12 and the hole #13, which are not illustrated in FIG. 23, are illustrated as being difficult holes. In addition, in FIG. 25, shots of a driver P61, a second P62, and a middle P63 are illustrated. In the example illustrated in FIG. 25, the determination standard P65 is set to, for example, 12 points in the evaluation score (the total score) on a scale of one to twenty-five. In this example, in comparison with the order of the driver P61, the second P62, the middle P63, . . . , the evaluation points (total score) of the second P62 (the second shot) of the hole #5 and the middle P63 (the middle shot) of the hole #1 and the hole #13 is lower than the determination standard value P65, and extremely low compared with other shots. Therefore, in the weak hole #1, hole #5, and hole #13, it is a mistake in the second shot and the middle shot, it is indicated that such a shot is weak (weak point).

In addition, in step S308 where analyzing of the elapsed time is performed, the weak points of play are found from a time course of play. In other words, the weak point is estimated from the flow of each shot of the weak hole.

In step S308, the elapsed time of each swing operation is measured by a change in acceleration from the preparation for swing (start of operation measurement) to the end of swing. As illustrated in FIG. 26, as the time t elapses, the acceleration related to the swing operation is generated with a large peak every time some play (operation) is performed. In the example illustrated in FIG. 26, slightly great acceleration of the first practice swing or the air shot, the acceleration slowly and greatly changed of the address, and the great acceleration when the swing is performed are generated. At a peak P70 of the acceleration occurring at the time of the swing, when the impact of the shot occurs, the acceleration rapidly decreases thereafter, the shot ends, and the measurement also ends. In addition, the elapsed time from the start to the impact is defined as T.

Here, a specific example of step S308 will be described with reference to FIG. 27. In FIG. 27, the horizontal axis represents each shot (for example, an order of the first shot, the second shot, and the third shot), and the vertical axis represents the elapsed time T in each shot. It can be considered that the elapsed time T is as short as possible and moderate length is good playing with good pace and good play. Conversely, in a case where the elapsed time T is longer than the general time (an appropriate value according to a determination standard P85 indicated by a broken line in the drawing) of the elapsed time T, for example, it takes time to swing because straying about what type of shot to select, stance, the address, a launch direction, or the like, and the pace of the play becomes bad, it is not necessarily a good play.

In the example illustrated in FIG. 27, the hole #1 indicated by heading P81 and the hole #5 indicated by heading P82 are illustrated. In the hole #1, it is found that the elapsed time T of each shot is located in the vicinity of an adequate value according to the determination standard P85 indicated by a broken line in the drawing, and playing with rhythm at an appropriate elapsed time T. On the other hand, the hole #5 has three shots (the fourth shot, the fifth shot, and the sixth shot in the position surrounded by a dotted line P83 in the drawing) in which the elapsed time T largely exceeds the appropriate value indicated by the determination standard P85. It is found that the rhythm is missed up and it contributes to a decrease in the evaluation point (the score).

Instead of the elapsed time T, the number of peaks of acceleration up to the impact can be used as a measure of the elapsed time. If there is no hesitation in play, as illustrated in FIG. 26, two or three times of practice wings or air shots lead to the swing. However, if there are many hesitancies and badness, the practice swing, the air shot or re-address increase. Accordingly, if the number of peaks of the acceleration up to the impact is smaller than the predetermined value, it can be estimated that the user is playing with a good rhythm, and if the number of peaks of the acceleration to the impact is larger than the predetermined value, it can be estimated that the rhythm is messed up.

FIG. 28 illustrates the time procedure of the recording of the play for the above-described analysis. The play is defined for each hole such as a hole #1 or a hole #2, and each hole includes a plurality of shots such as the driver and the second. The movement from the start to the end of each shot is recorded. Recording can be performed during principle shot. Acquisition and recording of the position by the GPS may be performed at least at the time of arriving at each hole, at the end of each shot, when exiting the hole, but may acquire the entire processes. Also, the score input is manual input by the player at the end of play at the hole.

Next, returning to the flowchart of FIG. 21, the weak play is detected based on the detection result (analysis result) as described above, (step S310). The advice on the play to be overcome based on the detection result is displayed by, for example, image data or the like (step S312). A series of procedures for obtaining the play state including the strong point and the weak point in the golf swing of the user 2 from the detection results at the plurality of swings based on the respective scores (evaluation results) quantified by the above steps is ended. The play state can be output by input golf equipment information and the detection results at the plurality of swings described above. The user 2 performs the exercise along the displayed advice.

### 1-7. Display Example of Screen Indicating Swing Analysis Result

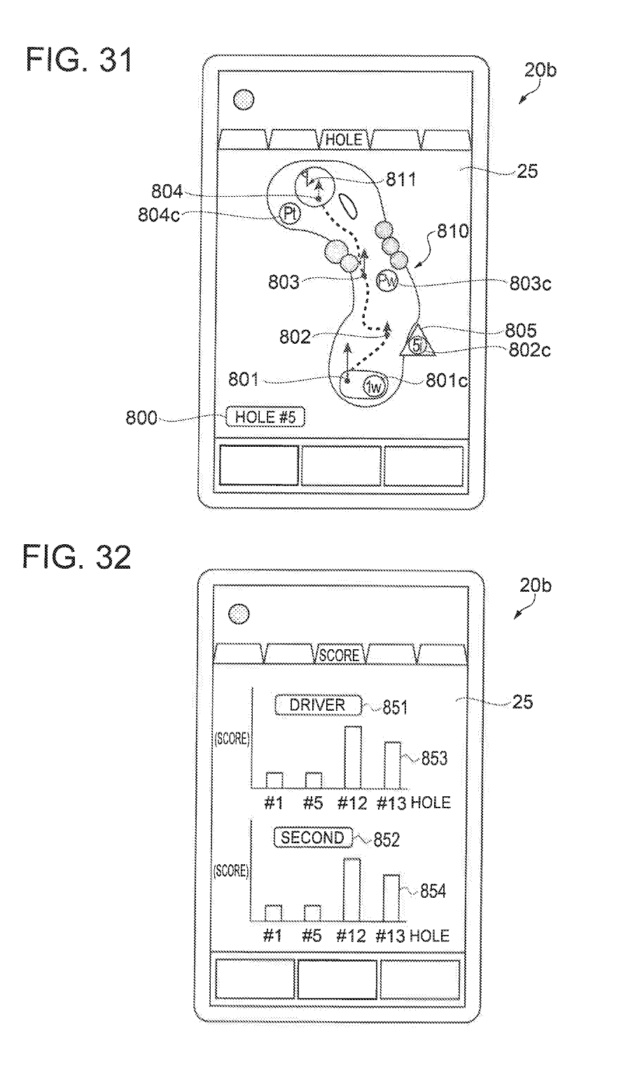

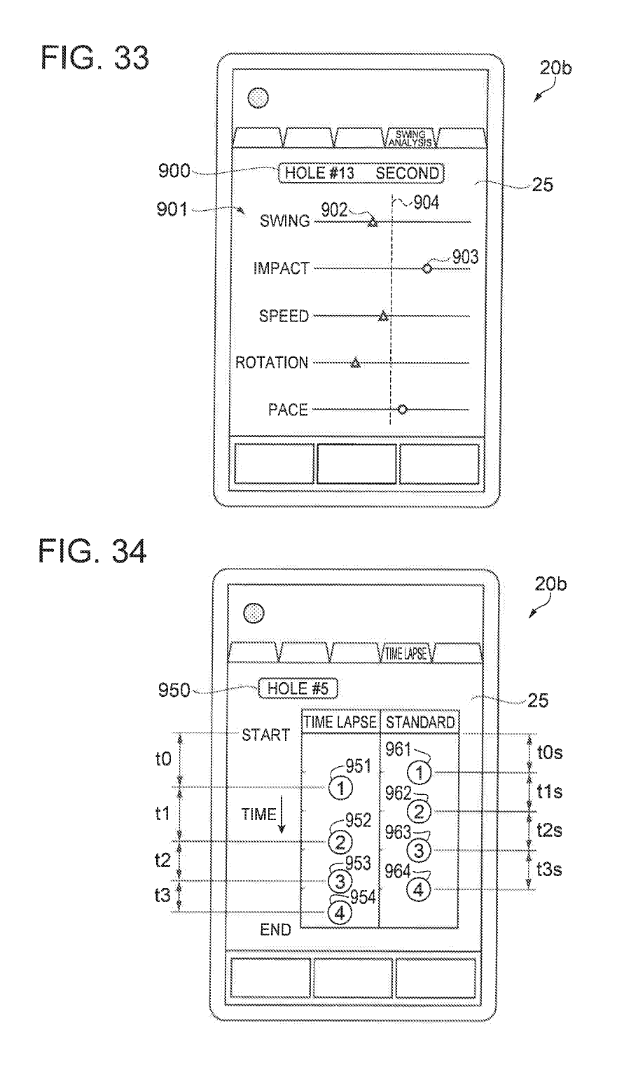

The analysis result in each step is displayed as various types of images including characteristics or symbols on the display unit 25 based on the image data generated by the image data generation unit 212. Display examples will be described with reference to FIGS. 29 to 34. FIG. 29 is a diagram illustrating a display example 1 (entire) used for advice on user's weak point obtained from an analysis result. FIG. 30 is a diagram illustrating a display example 2 (a weak hole) used for advice on the user's weak point obtained from the analysis result. FIG. 31 is a diagram illustrating a display example 3 (a situation of each hole) used for advice on the user's weak point obtained from the analysis result. FIG. 32 is a diagram illustrating a display example 4 (a score situation for hitting balls relating to the weak hole) used for advice on the user's weak point obtained from the analysis result. FIG. 33 is a diagram illustrating a display example 5 (an analysis result of the swing) used for advice on the user's weak point obtained from the analysis result. FIG. 34 is a diagram illustrating a display example 6 (an elapsed time of swing for hitting balls) used for advice on the user's weak point obtained from the analysis result.

### Display Example 1

Firstly, as a display example displayed on the display unit 25 of the mobile equipment 20b such as a smartphone or a tablet, Display Example 1 (entire) used for advice on the weak point of the user 2 obtained from the analysis result will be described with reference to FIG. 29. The display unit 25 in the following display examples is assumed to be a touch panel of a smartphone, or the like for example.

As illustrated in FIG. 29, a hole number 701 of a hole constituting a course of a golf field to be rounded is shown on the display unit 25. A mark 702 as indicated by a black circle in the drawing is shown corresponding to the hole detected as a weak hole. In this example, a hole #1, a hole #5, a hole #12, and a hole #13 are detected as weak holes.

### Display Example 2

Next, Display Example 2 (the weak hole) used for advice on the weak point of user 2 obtained from the analysis result will be described as a display example displayed on the display unit 25 of the mobile equipment 20b with reference to FIG. 30.

In FIG. 30, a course overview of the holes (in this example, hole #1 and hole #5) detected as the weak hole is displayed. As a detailed display, hole names 751 and 752 detected as weak holes and course overviews 751a and 752a corresponding to the holes are shown. The display as illustrated in FIG. 30 can be performed by tapping the displayed portion related to the hole name for which the course overview is to be displayed on the display illustrated in FIG. 29.

### Display Example 3

Next, in the display of FIG. 30, a detailed analysis result of the hole can be displayed on the display unit 25 of the mobile equipment 20b by tapping a portion of the hole detected as the weak hole. An example of the display of the analysis result will be described as Display Example 3 with reference to FIG. 31.

Display example 3 illustrated in FIG. 31 shows a case where the hole #5 is selected as a hole requiring to detailed analysis results. Display example 3 includes a hole name (hole #5) 800, a hole overview 810, a movement trajectory for each hitting order of the holes (shot) indicated by a broken line, and an evaluation point (score) of the analysis result in each shot, and a pin mark 811 are displayed. The evaluation points of the analysis result in each shot are indicated by the height of an arrow illustrated in the drawing, and the higher the evaluation point is, the longer the evaluation point is, the longer the length of the arrow is displayed. Further, the movement trajectory can be calculated based on the position information from the position information acquisition unit 43.

According to Display Example 3, the play state is output in combination of the detection result of the motion state in the golf swing quantified based on the output from the inertial sensor and the acquisition result of the position information from the position information acquisition unit 43, a movement state including a movement trajectory such as how the user 2 moved from the hitting position toward the next hitting position, and the like can be known, and it is possible to more precisely perform the output in the play state.

In particular, a tee shot position 801 as a first shot in a tee ground, a second shot position 802 as a second shot, an approach shot position 803 as a third shot, and a putting position 804 as a fourth shot on the green are shown. In addition, the selection status of the club in each shot, for example, a mark 801c indicating a first shot club (number one wood as a driver), a mark 802c indicating a second shot club (number five iron), a mark 803c indicating a third shot club (pitching wedge), and a mark 804c indicating a fourth shot club (putt), which are arranged near each shot position and displayed. In addition, a Δ mark 805 is displayed so as to surround the mark 802c indicating the selection state of the club in the weak shot with low evaluation point (score) (in the example, the second shot). By displaying the A mark 805, it is possible to easily confirm which shot stumbled.

### Display Example 4

In addition, in the display of FIG. 30, by tapping a hole portion detected as the weak hole, as illustrated in FIG. 32, the evaluation points (scores) of each hole are displayed on the display unit 25 of the mobile equipment 20b to compare the evaluation points (scores) of holes. In particular, a mark indicating hitting order (shot), for example, a mark 851 indicating a driver and a mark 852 indicating a second are displayed, and the evaluation points (scores) for each hole in each hitting order (shot) are indicated on bar charts 853 and 854.

### Display Example 5

By tapping a portion of the bar chart 853 indicating the evaluation point (score), for example, as illustrated in FIG. 33, in the graph of a heading 900 showing the hole name and the shot name, the five indices (evaluation items) 901 can be confirmed in detail. In this example, three evaluation points (scores) are set as a determination standard 904, a case where the evaluation points (scores) are three or more are indicated by a ◯ mark 903, and a case where the evaluation points (scores) are three or less are displayed by a Δ mark 902. Accordingly, it is possible to easily know a more detailed weak point.

### Display Example 6

Next, as illustrated in FIG. 34, the elapsed time between each shot from the start to the end of the hole, in other words, when the number of shots are hit, by displaying and comparing with standard elapsed time are displayed on the display unit 25 of the mobile equipment mobile equipment mobile equipment 20b, the user can know about the collapse of the rhythm by bad time, being lost, being chased by the following player, or the like. In particular, as illustrated in FIG. 34, a hole name (hole #5) 950, a display mark 951 indicating the timing at which each shot of the hole #5 was performed (the display mark 951 indicating the first shot, a display mark 952 indicating the second shot, a display mark 953 indicating the third shot, and a display mark 954 indicating the fourth shot), a display mark indicating the standard shot timing (a display mark 961 indicating the first shot, a display mark 962 indicating the second shot, a display mark 963 indicating the third shot, and a display mark 964 indicating the fourth shot) are displayed.

The elapsed time between each of shots can be known from the indicated position of the display mark indicating the timing of this shot. In the example illustrated in FIG. 34, the elapsed time of the actual shot is shown as an absolute time in the column of “elapsed time” in the drawing, and the average elapsed time (absolute time) of the hole is shown as a comparison target. In particular, it is an elapsed time t0 from the start to the first shot, and an elapsed time t0s is shown as the standard elapsed time corresponding thereto. Similarly, an elapsed time t1 between the first shot and the second shot, an elapsed time t2 between the second shot and a third shot, an elapsed time t3 between the third shot and a fourth shot, and standard elapsed times t1s, t2s, and t3s corresponding to the times t1s, t2s, and t3s are shown. In this example, it can be found that the elapsed time t0 from the start to the first shot is longer than the standard elapsed time t0s corresponding thereto. In addition, the elapsed time t1 from the first shot to the second shot is also longer than the standard elapsed time t1s corresponding thereto. In addition, it can be found that the elapsed time t3 from the third shot to the fourth shot is shorter than the standard elapsed time t3s corresponding thereto, that is, it is a hurry shot. In addition, it can be found that the total elapsed time of the actual shot at hole #5 is longer than the total of the standard elapsed time. Accordingly, it can be inferred that there was some kind of hesitation or trouble.

In Display Example 6 described above, an example is described in which a display mark (for example, a display mark 951 indicating the first shot) indicating the timing of shot in the hole is displayed. However, it is not limited thereto. As another display example, for example, in the hole, the number information of the club used for performing shot may use the sings, for example, “1W” representing number one wood, “5I” representing number five iron, “PW” representing pitching wedge, “PT” representing a putter,” and the like.

In addition to the above-described display examples, the display method indicating the analysis result as described above may be applied to a place where there is a problem (a bad hole, a type of a weak hole or a weak shot, a state of a weak swing, a problematic elapsed time, or the like) can be indicated by character display, for example, by itemization.

By viewing the exemplified display as described above by the user 2, since it is objective to know what kind of the weak point the user 2 has, the display can be used as a reference when exercising. When exercising, the user may proceed with confirming detailed weak points with various displays according to the above display example.

According to the motion analyzing system 1 as described above and the swing analyzing apparatus 20 as an example of a motion analyzing apparatus, the following effects are obtained.

(1) It is detected whether the numerical value which is obtained by quantifying the motion state based on the output from the sensor unit 10 including the inertial sensor (the acceleration sensor 12 and the angular velocity sensor 14) deviates from the predetermined range, and the play state from the result in the detected plurality of swings is output from the processing unit 21 as the output unit. Accordingly, the user can know the weak point in the swing of a golf. As a result, the user can exercise the play after knowing the weak point of the play, and can perform efficient exercise corresponding to the weak point.

(2) The motion state in the golf swing is quantified by the plurality of quantifiable indices and it is possible to detect that the numerical value deviates from the predetermined range on the plurality of indices. Accordingly, it is possible to more precisely perform the output in the play state.

(3) Since the play state is output with a combination of the detection result of the motion state, which is quantified based on the output from the inertial sensor (the acceleration sensor 12 and the angular velocity sensor 14), in the plurality of swings of the golf and the input result in the golf score, it is possible to more precisely perform the output in the play state.

(4) Since the play state is output with a combination of the detection result of the motion state, which is quantified based on the output from the inertial sensor (the acceleration sensor 12 and the angular velocity sensor 14), in the plurality of golf swings and the golf equipment information, it is possible to more precisely perform the output in the play state.

(5) Since the play state is output with a combination of the detection result of the motion state, which is quantified based on the output from the inertial sensor (the acceleration sensor 12 and the angular velocity sensor 14), in the plurality of golf swings and the acquisition result of the position information from the position information acquisition unit 43, it is possible to more precisely perform the output in the play state including the motion state of the user 2 or the like.

In addition, according to the swing analyzing method as described above, it is detected whether the numerical value which is obtained by quantifying the motion state based on the output from the sensor unit 10 including the inertial sensor (the acceleration sensor 12 and the angular velocity sensor 14) deviates from the predetermined range, and the play state is output from the result in the detected plurality of swings. Accordingly, the user 2 can know the weak point in his or her own golf swing. The user can exercise the play after knowing the weak point of the play, and can perform efficient exercise corresponding to the weak point. In addition, since the motion state is quantified by the plurality of indices, it is possible to more precisely perform the output in the play state.

The invention includes constitutions that are substantially identical with the constitutions described in the embodiments (for example, constitutions having identical functions, methods, and results, or constitutions having identical purposes and results). Furthermore, the invention includes constitutions in which the parts that are not essential in the constitutions described in the embodiments have been changed. Further, the invention includes constitutions which provide the same operating effects, or constitutions which can achieve the same purpose, as the constitutions described in the embodiments. Further, the invention includes constitutions to which will-known technologies have been added to the constitutions described in the embodiments.

What is claimed is:

1. A motion analyzing apparatus, comprising:
a computation unit that quantifies a golf swing based on an output of an inertial sensor;
a storage that stores a numerical value which is obtained by quantifying a plurality of the swings; and
an output unit that detects the numerical value deviating from a predetermined range among a plurality of the numerical values and outputs a play state.

2. The motion analyzing apparatus according to claim 1,
wherein a motion state in the golf swing is quantified, and
wherein the motion state includes a plurality of quantifiable indices.

3. The motion analyzing apparatus according to claim 1,
wherein the output unit outputs the play state from an input result of a golf score and a plurality of detection results.

4. The motion analyzing apparatus according to claim 1,
wherein the output unit outputs the play state from golf equipment information and the detection result.

5. The motion analyzing apparatus according to claim 1, further comprising:
a position information acquisition unit,
wherein the output unit outputs the play state from an acquisition result of position information from the position information acquisition unit and the detection result.

6. The motion analyzing apparatus according to claim 1,
wherein the play state is a number of a good or weak hole or club.

7. A motion analyzing system comprising:
an inertial sensor;
a computation unit that quantifies a swing of a golf based on an output of the inertial sensor;
a storage that stores a numerical value which is obtained by quantifying a plurality of the swings; and
an output unit that detects the numerical value, which is quantified by the computation unit, deviating from a predetermined range among a plurality of the numerical values and outputs a play state from the detection result in the plurality of swings.

8. The motion analyzing system according to claim 7, further comprising:
a position information acquisition unit,
wherein the output unit outputs the play state from an acquisition result of position information from the position information acquisition unit and the detection result.

9. A motion analyzing method comprising:
quantifying a swing of a golf based on an output of an inertial sensor;
storing a numerical value which is obtained by quantifying a plurality of the swings; and
detecting the numerical value, which is quantified by the operation unit, deviating from a predetermined range among a plurality of the numerical values and outputting a play state from the detection result in the plurality of swings.

10. The motion analyzing method according to claim 9,
wherein the motion state includes a plurality of quantifiable indices.
